(19) United States
(12) Patent Application Publication
(10) Pub. No.: US 2026/0116824 A1
(43) Pub. Date: Apr. 30, 2026

(54) MAGNESIUM OXIDE AND WOLLASTONITE COMPOSITIONS, BOARDS, AND METHODS

(71) Applicant: US MgO Company, LLC, Mint Hill, NC (US)

(72) Inventors: M. Steven Doggett, Hugo, MN (US); Jarrett B. Davis, Wilmington, NC (US)

(21) Appl. No.: 19/369,099

(22) Filed: Oct. 24, 2025

Related U.S. Application Data
(60) Provisional application No. 63/712,259, filed on Oct. 25, 2024.

(51) Int. Cl. C04B 28/30; C04B 9/02; C04B 9/04; C04B 9/11; C04B 12/00; C04B 24/08; C04B 103/65

(52) U.S. Cl. CPC C04B 28/30; C04B 9/02; C04B 9/04; C04B 9/11; C04B 12/007; C04B 24/085; C04B 2103/65; C04B 2201/50

(57) ABSTRACT

Compositions, boards, mixtures, slurries, and methods of magnesium oxide, phosphate, sulfate, and/or chloride, and wollastonite. In at least one embodiment, compositions and boards include magnesium oxide, phosphate, sulfate, and/or chloride, and wollastonite, for example, for uses, such as construction and other applications.

### CROSS-REFERENCE TO RELATED APPLICATIONS

This application claims priority to U.S. Provisional Patent Application No. 63/712,259, filed Oct. 25, 2024, and entitled “MAGNESIUM OXIDE, WOLLASTONITE, AND PHOSPHATE COMPOSITIONS AND METHODS,” which is hereby incorporated by reference herein in its entirety for all purposes.

### FIELD

At least one embodiment pertains to magnesium oxide, wollastonite, sulfate, chloride and/or phosphate compositions and methods. For example, at least one embodiment, magnesium oxide, wollastonite, sulfate, chloride and/or phosphate compositions, boards, slurries, and methods, according to various novel compositions and techniques described further herein.

### BACKGROUND

Fire safety and durability represent some of the material properties needed in the design and construction of buildings. Construction materials with, for example, fire resistant and durable properties can be improved.

### BRIEF DESCRIPTION OF DRAWINGS

Various embodiments and techniques will be described with reference to the drawings, in which:

FIG. 1 illustrates a board, according to at least one embodiment;

FIG. 2 illustrates a board including layered structures, according to at least one embodiment;

FIGS. 3A-3D illustrate a board including example drainage patterns, according to at least one embodiment;

FIG. 4 illustrates an example assembly showing a board with additional structural components, according to at least one embodiment;

FIG. 5 illustrates a method of making a board, according to at least one embodiment;

FIG. 6 illustrates another method of making a board, according to at least one embodiment;

FIG. 7 illustrates a method of making a sulfate board, according to at least one embodiment;

FIG. 8 illustrates a method of making a sulfate board, according to at least one embodiment;

FIG. 9 illustrates a method of making a chloride board, according to at least one embodiment;

FIG. 10 illustrates a method of making a chloride board, according to at least one embodiment;

FIG. 11A and FIG. 11B illustrate an example comparing combustibility of a conventional magnesium oxychloride panel to an example panel described herein, according to at least one embodiment;

FIG. 12 illustrates examples of water absorption characteristics of example panels described herein, according to at least one embodiment;

FIG. 13 illustrates additional examples of water absorption characteristics of example panels described herein, according to at least one embodiment; and

FIG. 14 illustrates additional examples of water absorption characteristics of example panels described herein, according to at least one embodiment; and

FIG. 15 illustrates additional examples of water absorption characteristics of example panels described herein, according to at least one embodiment.

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

In at least one embodiment, a composition and/or slurry described further herein may include a combination of components. A composition and/or slurry described further herein may include a magnesium oxide. A composition and/or slurry described further herein can include wollastonite. A composition and/or slurry described further herein can include a phosphate salt, such as an acid phosphate salt. A composition and/or slurry described further herein can include a sulfate salt. A composition and/or slurry described further herein can include a chloride salt. A composition and/or slurry can include a filler, such as vermiculite, perlite, pumice, a fiber (e.g., a fiberglass fiber, a basalt fiber, and/or a carbon fiber), or a combination thereof. A composition and/or slurry can include a biopolymer, such as casein. A composition and/or slurry can include an additional retarder added as another component of the composition and/or slurry, such as borax and/or citric acid. A composition and/or slurry can include additional materials, such as a hydrophobic agent and/or a fatty acid. A composition and/or slurry described further herein can include a magnesium oxide, wollastonite, and a phosphate salt, such as an acid phosphate salt. A composition and/or slurry described further herein can include a magnesium oxide, wollastonite, and a sulfate salt. A composition and/or slurry described further herein can include a magnesium oxide, wollastonite, and a chloride salt. A composition and/or slurry described further herein can include a magnesium oxide, wollastonite, and a phosphate salt, such as an acid phosphate salt, and vermiculite, perlite, or vermiculite and perlite. A composition and/or slurry described further herein can include a magnesium oxide, wollastonite, and a sulfate salt, and vermiculite, perlite, or vermiculite and perlite. A composition and/or slurry described further herein can include a magnesium oxide, wollastonite, and a chloride salt, and vermiculite, perlite, or vermiculite and perlite. A composition and/or slurry described further herein can include a magnesium oxide, wollastonite, and a phosphate salt, such as an acid phosphate salt, vermiculite, perlite, or vermiculite and perlite, and a biopolymer, such as casein. A composition and/or slurry described further herein can include a magnesium oxide, wollastonite, and a sulfate salt, vermiculite, perlite, or vermiculite and perlite, and a biopolymer, such as casein. A composition and/or slurry described further herein can include a magnesium oxide, wollastonite, and a chloride salt, vermiculite, perlite, or vermiculite and perlite, and a biopolymer, such as casein. It will be appreciated that other combinations of various components described herein are envisioned for the compositions and/or slurries.

In at least one embodiment, a composition described further herein may be in the form of a powder. A composition described further herein can be in the form of a slurry, which can include a liquid (e.g., an aqueous solution, such as water) that can be combined with a powder form of the compositions described further herein. Additional components may be included in the liquid. For example, a phosphoric acid (e.g., H₃PO₄), a sulfate salt, and/or a chloride salt can be mixed with water. Phosphoric acid in the liquid can be used, e.g., to affect, such as reduce, how much phosphate salt may be used in a powder form of the composition prior to forming the slurry. When included in a slurry described herein, a liquid (e.g., an aqueous solution, such as water) can be present in a range between about 20% to about 40%, about 30% to about 40% of a total weight of a slurry, between about 30% to about 35% of the total weight of a slurry, between about 35% to about 40% of the total weight of a slurry, between about 32% to about 36% of the total weight of a slurry, between about 30% to about 36% of the total weight of a slurry, and between about 34% to about 38% of the total weight of a slurry. For example, a total formulation weight of a slurry can include all components of a slurry (e.g., powdered composition components and water together). A total weight of a slurry can include, for example, weight of magnesium oxide, wollastonite, phosphate salt, water, and other components, such as a filler and/or hydrophobic agent. A slurry can be uncured cementitious material. Uncured cementitious material including compositions described herein can cured to form a solid cementitious material (e.g., a cementitious matrix). A composition and/or slurry described herein can be used, e.g., as precursor or starting materials, to make a solid material, such as a coating, a board, or other solid material having a formed shape. The compositions, solid materials (e.g., boards), and slurries described further herein can be void or free of (e.g., 0%) crystalline silica (SiO₂).

In at least one embodiment, a composition and/or slurry described further herein can include a magnesium oxide. A magnesium oxide can include MgO. A magnesium oxide may include different calcined forms of magnesium oxide. For example, magnesium oxide may be crudely-burned. A crudely-burned magnesium oxide may be produced from calcining temperatures below about 700 degrees Celsius. For example, magnesium oxide can be light-burned. A light-burned magnesium oxide can be produced from calcining temperatures of about 700-1100 degrees Celsius. A light-burned magnesium oxide may be produced from calcining temperatures of about 700-900 degrees Celsius. A light-burned magnesium oxide can be produced from calcining temperatures of about 700-800 degrees Celsius. In at least one embodiment, magnesium oxide can be hard-burned. A hard-burned magnesium oxide can be produced from calcining temperatures between about 1100-1400 degrees Celsius. In at least one embodiment, magnesium oxide can be dead-burned. A dead-burned magnesium oxide can be produced from calcining temperatures between greater than about 1400 degrees Celsius. In at least one embodiment, magnesium oxide can be calcined at temperatures less than about 700 degrees Celsius. A composition and/or slurry described further herein can include any combination of calcined forms of magnesium oxide (e.g., light-burned magnesium oxide and dead-burned magnesium oxide). Various methods can be used for calcining the magnesium oxide. For example, a furnace, kiln, or other heating device can be used to calcine the magnesium oxide. Magnesium oxide can be present in the compositions described herein at a percentage weight of the total weight of a composition and/or slurry described herein. A slurry that includes a liquid (e.g., an aqueous solution, such as water) can have a total formulation weight that includes a final combined weight of all components (e.g., powdered composition components and water together). A slurry that includes a liquid (e.g., an aqueous solution, such as water) can include, for example, magnesium oxide (e.g., light-burned magnesium oxide) ranging from about 13% to about 30% of a total weight of the slurry (e.g., 1.3 kg of MgO in a 10 kg slurry, or 13%), from about 15% to about 25% of a total weight of the slurry, from about 20% to about 25% of a total weight of the slurry, from about 25% to about 30% of a total weight of the slurry, from about 18% to about 20% of a total weight of the slurry, from about 22% to about 24% of a total weight of the slurry, and from about 18% to about 22% of a total weight of the slurry. In some embodiments, a slurry that includes a sulfate salt and a liquid (e.g., an aqueous solution, such as water) can include, for example, magnesium oxide ranging from about 20% to about 55% of a total weight of the slurry, from about 20% to about 40%, and from about 25% to about 35% of a total weight of the slurry. In some embodiments, a slurry that includes a chloride salt and a liquid (e.g., an aqueous solution, such as water) can include, for example, magnesium oxide ranging from about 20% to about 50% of a total weight of the slurry, from about 20% to about 40%, and from about 25% to about 30% of a total weight of the slurry.

In at least one embodiment, a composition and/or slurry described further herein can include wollastonite. Wollastonite can include CaSiO₃. Wollastonite can include different grades (e.g., wollastonite from Vanderbilt Minerals, such as Vansil W-10 and W-20). Wollastonite may be used to modify working times for the compositions, slurries, and boards described further herein. For example, light-burned magnesium oxide can have increased reactivity, and existing retarders used in slowing the set or cure of existing cements can have limiting effect and are typically detrimental to strength properties when used in excess. In compositions, slurries, boards, etc., described herein, wollastonite can act as a retarder to provide longer working times that allow the slurry to be formed into shapes before hardening or becoming too viscous to be useful, e.g., to allow for making boards described further herein. Wollastonite may also be added to increase strength of the boards as well as increase dimensional stability, such as reducing cracking and/or warping, as described further herein. For example, increasing amounts of wollastonite in solid materials (e.g., boards) described herein can be used to increase flexural strength of the solid materials (e.g., boards). Wollastonite can be used to provide a flexural strength (MPa) of a solid material described herein (e.g., a board) of greater than about 10 MPa, greater than about 15 MPa, greater than about 20 MPa, greater than about 25 MPa, between about 10 MPa to about 15 MPa, between about 10 MPa to about 25 MPa, between about 15 MPa to about 20 MPa. Wollastonite can be used to reduce or eliminate warping of a solid material described herein (e.g., a board) including 0 millimeters (mm) of warping or bending over at least 1 foot of a dimension of a board having a width×height×length, 1 mm of warping or bending over at least 1 foot of a dimension of a board having a width×height×length, or 2 mm of warping or bending over at least 1 foot of a dimension of a board having a width×height×length. Wollastonite also can be used to reduce or eliminate deliquescence (e.g., surface droplets forming on the surface of a board) in the solid materials formed using a composition and/or slurry described further herein. For example, solid materials formed using a composition and/or slurry including wollastonite described further herein do not exhibit deliquescence, e.g., after at least 48 hours at about 35 degrees F. and about 90% relative humidity. Solid materials formed using a composition and/or slurry including wollastonite described further herein exhibited, for example, a free chloride percentage weight of less than about 4%. A slurry that includes a liquid (e.g., an aqueous solution, such as water) can, for example, include wollastonite (and, in some embodiments, a phosphate salt) ranging from about 5% to about 30% of a total weight of the slurry, from about 5% to about 20% of a total weight of the slurry, from about 4% to about 18% of a total weight of the slurry (e.g., 0.4 kg of wollastonite in a 10 kg slurry, or 4%), from about 6% to about 16% of a total weight of the slurry, from about 8% to about 12% of a total weight of the slurry, from about 10% to about 16% of a total weight of the slurry, and from about 4% to about 10% of a total weight of the slurry. In some embodiments, a slurry that includes a sulfate salt and a liquid (e.g., an aqueous solution, such as water) can include, for example, wollastonite ranging from about 5% to about 30% of a total weight of the slurry, from about 5% to about 20%, and from about 7% to about 15% of a total weight of the slurry. In some embodiments, a slurry that includes a chloride salt and a liquid (e.g., an aqueous solution, such as water) can include, for example, wollastonite ranging from about 5% to about 30% of a total weight of the slurry, from about 5% to about 20%, and from about 5% to about 10% of a total weight of the slurry. In some embodiments, a total weight of a slurry used to form a solid material described herein can include at least about 5% weight of wollastonite, at least about 10% weight of wollastonite, at least about 15% weight of wollastonite, at least about 20% weight of wollastonite, and at least about 25% weight of wollastonite.

In at least one embodiment, a composition and/or slurry can include a ratio of wollastonite to magnesium oxide. A ratio of wollastonite to magnesium oxide can be greater than about 0.3 by weight (e.g., 0.3 kilograms of wollastonite to every 1 kilogram of magnesium oxide). A ratio of wollastonite to magnesium oxide may be greater than about 0.5 by weight. A ratio of wollastonite to magnesium oxide may be greater than about 0.6 by weight. A ratio of wollastonite to magnesium oxide can be greater than about 0.7 by weight. A ratio of wollastonite to magnesium oxide can be greater than about 0.8 by weight. A ratio of wollastonite to magnesium oxide can be greater than about 0.9 by weight. A ratio of wollastonite to magnesium oxide may be greater than about 1.0 by weight. A ratio of wollastonite to magnesium oxide can be greater than about 1.1 by weight. A ratio of wollastonite to magnesium oxide can be greater than about 1.2 by weight. A ratio of wollastonite to magnesium oxide can be between about 0.3 and 1.2 by weight. A ratio of wollastonite to magnesium oxide may be between about 0.5 and 1.2 by weight. A ratio of wollastonite to magnesium oxide can be between about 0.6 and 1.2 by weight. A ratio of wollastonite to magnesium oxide may be between about 0.6 to 1.1 by weight. A ratio of wollastonite to magnesium oxide can be between about 0.6 to 1.0 by weight. A ratio of wollastonite to magnesium oxide can be between about 0.6 to 0.9 by weight. A ratio of wollastonite to magnesium oxide can be between about 0.6 to 0.8 by weight. A ratio of wollastonite to magnesium oxide may be between about 0.6 to 0.7 by weight.

In at least one embodiment, a composition and/or slurry described further herein can include a phosphate salt. A phosphate salt may include an acid phosphate salt. A phosphate salt may include a phosphoric acid (e.g., H₃PO₄), a polyphosphate (e.g., triphosphoric acid), a pyrophosphate (e.g., disodium pyrophosphate), an inorganic phosphate (e.g., KH₂PO₄), an organic phosphate (e.g., NH₄H₂PO₄ or a phosphonate), or any combination thereof. A phosphate salt can include a phosphoric acid (H₃PO₄). A phosphate salt can include ammonium dihydrogen phosphate (NH₄H₂PO₄). A phosphate salt may include monopotassium phosphate (KH₂PO₄), which can also be referred to as potassium dihydrogen phosphate. A phosphate salt may include any combination of phosphoric acid (H₃PO₄), ammonium dihydrogen phosphate (NH₄H₂PO₄), and/or monopotassium phosphate (KH₂PO₄). For example, phosphate salt can include phosphoric acid (H₃PO₄) and ammonium dihydrogen phosphate (NH₄H₂PO₄). Phosphate salt can include phosphoric acid (H₃PO₄) and a monopotassium phosphate (KH₂PO₄). A slurry that includes a liquid (e.g., an aqueous solution, such as water) can, for example, include a phosphate salt (e.g., KH₂PO₄) or a combination of two or more different phosphate salts ranging from about 20% to about 35% of a total weight of the slurry (e.g., 2 kg of phosphate salt in a 10 kg slurry, or 20%), from about 20% to about 25% of a total weight of the slurry, from about 25% to about 30% of a total weight of the slurry, from about 22% to about 28% of a total weight of the slurry, from about 24% to about 30% of a total weight of the slurry, and from about 26% to about 28% of a total weight of the slurry.

In at least one embodiment, a weight ratio of magnesium oxide to phosphate salt (e.g., MgO:acid phosphate salt, such as KH₂PO₄) may depend on the reactivity of the magnesium oxide.

For example, light-burned magnesium oxide can be more reactive than hard-burned and dead-burned magnesium oxide. Higher weight ratios of magnesium oxide to phosphate salt (e.g., MgO:acid phosphate salt, such as KH₂PO₄) may be used for hard-burned and dead-burned magnesium oxide as compared to light-burned magnesium oxide.

In at least one embodiment, a composition and/or slurry can include a weight ratio of magnesium oxide to phosphate salt that can be used for more reactive forms of magnesium oxide, such as light-burned magnesium oxide. A composition and/or slurry may include a weight ratio of magnesium oxide to phosphate salt (e.g., MgO:acid phosphate salt, such as KH₂PO₄) that is less than or equal to about 1.0. A composition and/or slurry may include a weight ratio of magnesium oxide to phosphate salt (e.g., MgO:acid phosphate salt, such as KH₂PO₄) that is less than about 0.9. A composition and/or slurry may include a weight ratio of magnesium oxide to phosphate salt (e.g., MgO:acid phosphate salt, such as KH₂PO₄) that is less than about 0.8. A composition and/or slurry can include a weight ratio of magnesium oxide to phosphate salt (e.g., MgO:acid phosphate salt, such as KH₂PO₄) that is less than about 0.7. A composition and/or slurry can include a weight ratio of magnesium oxide to phosphate salt (e.g., MgO:acid phosphate salt, such as KH₂PO₄) that is less than about 0.6. A composition and/or slurry can include a weight ratio of magnesium oxide to phosphate salt (e.g., MgO:acid phosphate salt, such as KH₂PO₄) that is between about 0.4 and 1.0. A composition and/or slurry can include a weight ratio of magnesium oxide to phosphate salt (e.g., MgO:acid phosphate salt, such as KH₂PO₄) that is between about 0.5 and 1.0. A composition and/or slurry may include a weight ratio of magnesium oxide to phosphate salt (e.g., MgO:acid phosphate salt, such as KH₂PO₄) that is between about 0.6 and 1.0. A composition and/or slurry can include a weight ratio of magnesium oxide to phosphate salt (e.g., MgO:acid phosphate salt, such as KH₂PO₄) that is between about 0.6 and 0.9. A composition and/or slurry can include a weight ratio of magnesium oxide to phosphate salt (e.g., MgO:acid phosphate salt, such as KH₂PO₄) that is between about 0.6 and 0.8. A composition and/or slurry may include a weight ratio of magnesium oxide to phosphate salt (e.g., MgO:acid phosphate salt, such as KH₂PO₄) that is between about 0.6 and 0.75.

In at least one embodiment, a composition and/or slurry can include a weight ratio of magnesium oxide to phosphate salt that can be used for less reactive forms of magnesium oxide, such as hard-burned or dead-burned magnesium oxide. A composition and/or slurry can include a weight ratio of magnesium oxide to phosphate salt (e.g., MgO:acid phosphate salt, such as KH₂PO₄) that is greater than about 1.0. A composition and/or slurry can include a weight ratio of magnesium oxide to phosphate salt (e.g., MgO:acid phosphate salt, such as KH₂PO₄) that is greater than about 1.2. A composition and/or slurry can include a weight ratio of magnesium oxide to phosphate salt (e.g., MgO:acid phosphate salt, such as KH₂PO₄) that is greater than about 1.4. A composition and/or slurry can include a weight ratio of magnesium oxide to phosphate salt (e.g., MgO:acid phosphate salt, such as KH₂PO₄) that is greater than about 1.6. A composition and/or slurry can include a weight ratio of magnesium oxide to phosphate salt (e.g., MgO:acid phosphate salt, such as KH₂PO₄) that is greater than about 1.8. A composition and/or slurry can include a weight ratio of magnesium oxide to phosphate salt (e.g., MgO:acid phosphate salt, such as KH₂PO₄) that is greater than about 2. A composition and/or slurry can include a weight ratio of magnesium oxide to phosphate salt (e.g., MgO:acid phosphate salt, such as KH₂PO₄) that is greater than about 2.2. A composition and/or slurry can include a weight ratio of magnesium oxide to phosphate salt (e.g., MgO:acid phosphate salt, such as KH₂PO₄) that is between about 1 and 2.2. A composition and/or slurry can include a weight ratio of magnesium oxide to phosphate salt (e.g., MgO:acid phosphate salt, such as KH₂PO₄) that is between about 1.5 and 2.2. A composition and/or slurry can include a weight ratio of magnesium oxide to phosphate salt (e.g., MgO:acid phosphate salt, such as KH₂PO₄) that is between about 1.8 and 2.2. A composition and/or slurry can include a weight ratio of magnesium oxide to phosphate salt (e.g., MgO:acid phosphate salt, such as KH₂PO₄) that is between about 1.9 and 2.1.

In at least one embodiment, a composition and/or slurry may include phosphate salt crystals of varied sizes and dimensions, such as rectangular or oblong in shape, which can, e.g., dissolve completely into ions in a slurry. Phosphate salt crystals (e.g., acid phosphate salt, such as KH₂PO₄) may be formed by grinding or pulverizing using, for example, a grinder or other equipment that can crush powder into smaller crystals. Smaller phosphate salt crystals (e.g., acid phosphate salt, such as KH₂PO₄) can result in dissociated ions of the salt in a slurry that can be formed into boards described further herein. Salt crystals that are not disassociated can remain in crystal form, which may be vulnerable to disassociation over time when exposed to water and that may weaken the boards. Disassociation of the smaller phosphate crystals (e.g., acid phosphate salt, such as KH₂PO₄) can increase strength and durability of the cementitious matrix and the board. An example aspect of a smaller crystal size (e.g., crystals having dimensions less than about 0.2 mm or smaller) includes increased working times for making the boards described further herein. A phosphate crystal (e.g., acid phosphate salt, such as KH₂PO₄) may have an irregular shape where one dimension of the crystal is longer than another dimension of the crystal. Phosphate salt crystals (e.g., acid phosphate salt, such as KH₂PO₄) can have dimensions of less than about 0.3 mm, 0.2 mm, or less than 0.1 mm, or less than 0.05 mm. Phosphate salt crystals (e.g., acid phosphate salt, such as KH₂PO₄) can have dimensions of less than about 0.05 mm×0.1 mm. Phosphate salt crystals (e.g., acid phosphate salt, such as KH₂PO₄) can have dimensions of between about 0.5 mm and 0.05 mm. Phosphate salt crystals (e.g., acid phosphate salt, such as KH₂PO₄) can have dimensions of between about 0.4 mm and 0.05 mm. Phosphate salt crystals (e.g., acid phosphate salt, such as KH₂PO₄) can have dimensions of between about 0.3 mm and 0.05 mm. Phosphate salt crystals (e.g., acid phosphate salt, such as KH₂PO₄) can have dimensions of between about 0.2 mm and 0.05 mm. Phosphate salt crystals (e.g., acid phosphate salt, such as KH₂PO₄) can have dimensions of between about 0.1 mm and 0.05 mm.

In at least one embodiment, a composition and/or slurry can include a sulfate salt. For example, magnesium oxysulfate (MOS) can include magnesium oxide and a sulfate salt. A sulfate salt can include magnesium sulfate. Magnesium sulfate can, for example, include hydrated forms of magnesium sulfate (MgSO₄·nH₂O), where n is an integer between 1 and 11, such as, e.g., magnesium sulfate heptahydrate (MgSO₄·7H₂O). Upon curing, several hydration products are possible, depending on molar ratios, formulation additives, and curing conditions. Hydration products can include, for example, 3-1-8 phase (3Mg(OH)₂·MgSO₄·8H₂O), 5-1-3 phase (5Mg(OH)₂·MgSO₄·3H₂O), and 5-1-7 phase (5Mg(OH)₂·MgSO₄·7H₂O). A slurry that includes a liquid (e.g., an aqueous solution, such as water) can, for example, include a sulfate salt (e.g., MgSO₄·7H₂O) ranging from about 15% to about 45% of a total weight of the slurry (e.g., 2 kg of sulfate salt in a 10 kg slurry, or 20%), from about 20% to about 40% of a total weight of the slurry, and from about 20% to about 30% of a total weight of the slurry.

In at least one embodiment, a composition and/or slurry can include a chloride salt. For example, magnesium oxychloride (MOC) (e.g., Sorel cement) can include magnesium oxide and chloride salt. A chloride salt can include magnesium chloride. Magnesium chloride can, for example, include hydrated forms of magnesium chloride (MgCl₂·nH₂O), where n is an integer between 1 and 12, such as, e.g., magnesium chloride hexahydrate (MgCl₂·6H₂O). Upon curing, several hydration products are possible, depending on molar ratios, formulation additives, and curing conditions. Different hydrates of magnesium chloride can be formed, each reflecting different MgO/MgCl₂ ratios, reaction temperatures, and microstructure. For example, hydrates can include 3-phase (3Mg(OH)₂·MgCl₂·8H₂O) and 5-phase (5Mg(OH)₂·MgCl₂·8H₂O). A slurry that includes a liquid (e.g., an aqueous solution, such as water) can, for example, include a chloride salt (e.g., MgCl₂·6H₂O) ranging from about 15% to about 40% of a total weight of the slurry (e.g., 2 kg of sulfate salt in a 10 kg slurry, or 20%), from about 20% to about 40% of a total weight of the slurry, and from about 20% to about 30% of a total weight of the slurry.

In at least one embodiment, a composition and/or slurry can also include a filler, such as vermiculite, perlite, pumice, a fiber (e.g., a fiberglass fiber, a basalt fiber, and/or a carbon fiber), or any combination thereof. Vermiculite, pumice, a fiber (e.g., a fiberglass fiber, a basalt fiber, and/or a carbon fiber), and perlite (individually or combined), for example, can be used as a lightweight filler and crack propagation mitigant. The compositions can include vermiculite ((Mg,Fe²⁺,Fe³⁺)₃[(Al,Si)+O₁₀](OH)₂·4H₂O). The compositions can include perlite, which may include 70-75% silicon dioxide: SiO₂, 12-15% aluminum oxide: Al₂O₃, 3-4% sodium oxide: Na₂O, 3-5% potassium oxide: K₂O, 0.5-2% iron oxide: Fe₂O₃, 0.2-0.7% magnesium oxide: MgO, and 0.5-1.5% calcium oxide: CaO, and 3-5% combined water (H₂O). The compositions and/or slurries can include vermiculite and perlite. A slurry that includes a liquid (e.g., an aqueous solution, such as water) can, for example, include a filler (e.g., vermiculite, perlite, pumice, a fiber (e.g., a fiberglass fiber, a basalt fiber, and/or a carbon fiber), or a combination thereof) ranging from about 3% to about 10% of a total weight of the slurry (e.g., 0.3 kg of a filler in a 10 kg slurry, or 3%), from about 4% to about 10% of a total weight of the slurry, from about 5% to about 8% of a total weight of the slurry, from about 8% to about 10% of a total weight of the slurry, from about 3% to about 5% of a total weight of the slurry, and from about 4% to about 6% of a total weight of the slurry. In some embodiments, a slurry that includes a sulfate salt and a liquid (e.g., an aqueous solution, such as water) can include, for example, a filler ranging from about 0.1% to about 9% of a total weight of the slurry, from about 2% to about 7%, and from about 2% to about 4% of a total weight of the slurry. In some embodiments, a slurry that includes a chloride salt and a liquid (e.g., an aqueous solution, such as water) can include, for example, a filler ranging from about 0.1% to about 9% of a total weight of the slurry, from about 1% to about 7%, and from about 3% to about 7% of a total weight of the slurry.

In at least one embodiment, a composition and/or slurry can also include a biopolymer. The biopolymer can include casein. The compositions and/or slurries may include casein to form air bubbles and/or pores in the boards described further herein, which can, for example, add flame retardance properties and/or impart matrix uniformity, improved strength and greater water resistance. Other biopolymers may be included in the compositions for a variety of purposes, and other biopolymers can include fatty acids, chitin, chitosan, gum Arabic, guar gum, carboxymethyl cellulose, citric acid, sodium alginate, xanthan gum, or any combination thereof. A slurry that includes a liquid (e.g., an aqueous solution, such as water) can, for example, include a biopolymer (e.g., one type of biopolymer, such as casein) ranging from about 0.1% to about 1.2% of a total weight of the slurry (e.g., 0.1 kg of a filler in a 10 kg slurry, or 1%), from about 0.2% to about 1% of a total weight of the slurry, from about 0.2% to about 0.8% of a total weight of the slurry, from about 0.2% to about 0.5% of a total weight of the slurry, and from about 0.5% to about 1% of a total weight of the slurry. For a combination of two or more biopolymers (e.g., casein and chitin), percentages may include a sum of one biopolymer plus another biopolymer (e.g., casein may be present at a percentage of 1% of a total weight of the slurry and chitin may be present at a percentage of 1% of a total weight of the slurry to provide a combined percentage of biopolymers of 2%). A slurry that includes a liquid (e.g., an aqueous solution, such as water) can, for example, include a combination of two or more biopolymers (e.g., casein and chitin) ranging from about 0.2% to about 2.4% of a total weight of the slurry, from about 0.4% to about 2% of a total weight of the slurry, from about 0.4% to about 1.6% of a total weight of the slurry, from about 0.4% to about 1% of a total weight of the slurry, and from about 1% to about 2% of a total weight of the slurry.

In at least one embodiment, a composition and/or slurry may include additional retarders that, e.g., can be added as additional components and may be used to increase working times of the slurries when making the boards described further herein. A retarder or retarders can include borax, citric acid, boric acid, ethanol, methanol, sodium alginate, glacial acetic acid, Lignosulfonates, sodium tripolyphosphate, or any combination thereof. A slurry that includes a liquid (e.g., an aqueous solution, such as water) can, for example, include a retarder (e.g., one type of retarder, such as borax) ranging from about 0.2% to about 2% of a total weight of the slurry (e.g., 0.2 kg of borax in a 10 kg slurry, or 2%), from about 0.2% to about 1.5% of a total weight of the slurry, from about 0.6% to about 1.1% of a total weight of the slurry, from about 0.7% to about 1.4% of a total weight of the slurry, from about 0.5% to about 1.5% of a total weight of the slurry, and from about 0.2% to about 1% of a total weight of the slurry. For a combination of two or more retarders (e.g., borax and citric acid), percentages may include a sum of one retarder plus another retarder (e.g., borax acid may be present at a percentage of 1% of a total weight of the slurry and citric acid may be present at a percentage of 1% of a total weight of the slurry to provide a combined percentage of retarders of 2%). A slurry that includes a liquid (e.g., an aqueous solution, such as water) can, for example, include a combination of two or more retarders (e.g., borax and citric acid) ranging from about 0.4% to about 4% of a total weight of the slurry (e.g., 0.4 kg of borax and citric acid combined in a 10 kg slurry, or 4%), from about 0.4% to about 3% of a total weight of the slurry, from about 1.2% to about 2.2% of a total weight of the slurry, from about 1.4% to about 2.8% of a total weight of the slurry, from about 1% to about 3% of a total weight of the slurry, and from about 0.4% to about 2% of a total weight of the slurry. In some embodiments, a slurry that includes a sulfate salt and a liquid (e.g., an aqueous solution, such as water) can include, for example, a retarder (e.g., citric acid) ranging from about 0.1% to about 5% of a total weight of the slurry, from about 2% to about 4% of a total weight of the slurry, from about 0.1% to about 1% of a total weight of the slurry, and from about 0.2% to about 0.3% of a total weight of the slurry. In some embodiments, a slurry that includes a chloride salt and a liquid (e.g., an aqueous solution, such as water) can include, for example, a retarder ranging from about 0.1% to about 5% of a total weight of the slurry, from about 2% to about 4% of a total weight of the slurry, from about 0.1% to about 1% of a total weight of the slurry, and from about 0.2% to about 0.3% of a total weight of the slurry. In some embodiments, a slurry that includes a liquid (e.g., an aqueous solution, such as water) and a sulfate and/or chloride salt can, for example, include a combination of two or more retarders (e.g., ethanol and citric acid) ranging from about 0.1% to about 6% of a total weight of the slurry (e.g., 0.4 kg of ethanol and citric acid combined in a 10 kg slurry, or 4%), from about 0.7% to about 3.3% of a total weight of the slurry, from about 0.5% to about 4% of a total weight of the slurry, and from about 1% to about 3% of a total weight of the slurry.

In at least one embodiment, a composition and/or slurry described further herein can also include materials to change water resistance, water repellency, and/or hydrophobic properties of the compositions, slurries, and/or boards described herein. Additional materials can include a hydrophobic agent (e.g., a siloxane, a silane, acrylics, and/or a silicone modified acrylic), a fatty acid (e.g. a stearic acid, a lauric acid, a caprylic acid, an oleic acid, and/or a capric acid), a wax emulsion (e.g. ethoxylated sorbitan monostearate and/or sorbitan monostearate), a metal stearate (e.g. calcium stearate, magnesium stearate, and/or zinc stearate), a densifier (e.g. fly ash, metakaolin, rice husk ash, sunflower ash, slag, silica fume, nanoSiO₂, nano-Al₂O₃, nano-Fe₂O₃, and/or fluorosilicate-based admixtures), a crystalline admixture (e.g., sodium acetate), and any combinations thereof. A slurry that includes a liquid (e.g., an aqueous solution, such as water) can, for example, include an additional material (e.g., one type of hydrophobic agent or fatty acid (e.g., a lauric acid)) ranging from about 0.2% to about 1.1% of a total weight of the slurry, from about 0.3% to about 1% of a total weight of the slurry, from about 0.4% to about 0.8% of a total weight of the slurry, from about 0.4% to about 0.6% of a total weight of the slurry, and from about 0.2% to about 0.4% of a total weight of the slurry. For a combination of two or more additional materials, percentages may include a sum of one additional material plus another additional material (e.g., a hydrophobic agent may be present at a percentage of 0.5% of a total weight of the slurry and a fatty acid may be present at a percentage of 0.6% of a total weight of the slurry to have a combined percentage of 1.1%). A slurry that includes a liquid (e.g., an aqueous solution, such as water) can, for example, include a combination of two or more additional materials (e.g., a hydrophobic agent and a fatty acid (e.g., a lauric acid)) ranging from about 0.4% to about 2.2% of a total weight of the slurry, from about 0.6% to about 2% of a total weight of the slurry, from about 0.8% to about 1.6% of a total weight of the slurry, from about 0.8% to about 1.2% of a total weight of the slurry, and from about 0.4% to about 0.8% of a total weight of the slurry. In some embodiments, a slurry that includes a sulfate salt and a liquid (e.g., an aqueous solution, such as water) can include, for example, an additional material (e.g., a lauric acid, a stearic acid, or a metal stearate) ranging from about 0.2% to about 2% of a total weight of the slurry, from about 0.3% to about 1% of a total weight of the slurry, from about 0.2% to about 1.5% of a total weight of the slurry, and from about 0.5% to about 2% of a total weight of the slurry. In some embodiments, a slurry that includes a chloride salt and a liquid (e.g., an aqueous solution, such as water) can include, for example, an additional material (e.g., a lauric acid, a stearic acid, or a metal stearate) ranging from about 0.2% to about 2% of a total weight of the slurry, from about 0.3% to about 1% of a total weight of the slurry, from about 0.2% to about 1.5% of a total weight of the slurry, and from about 0.5% to about 2% of a total weight of the slurry. In some embodiments, a slurry that includes a liquid (e.g., an aqueous solution, such as water) and a sulfate and/or chloride salt can, for example, include a combination of two or more additional materials (e.g., a lauric acid and a stearic acid or a metal stearate) ranging from about 0.4% to about 4% of a total weight of the slurry (e.g., 0.4 kg of ethanol and citric acid combined in a 10 kg slurry, or 4%) and from about 0.6% to about 2% of a total weight of the slurry, and from about 1% to about 4% of a total weight of the slurry.

In at least one embodiment, a board may be formed using a composition and/or slurry described further herein. For example, a composition and/or slurry described further herein can be used as precursor or starting materials that, e.g., can be set, hardened, or cured over time to form a solid material shape, such as a board. A “board” as used herein can also be referred to as a manufactured board, a manufactured construction panel, a sheathing panel, a cementitious panel, a panel, a sheet, or other structure that includes a height, width, and length when formed. The boards described herein can include a cured (or hardened or set) mixture of a composition and/or slurry described herein that can be a solid material. A cured solid material described herein can, for example, include magnesium oxide and the acid phosphate salt as K-struvite (MgKPO₄·6H₂O). Boards described herein can be used for a variety of applications, such as for building construction (e.g., as wall and roof panels, subflooring, ceiling panels, and/or tile backing).

In at least one embodiment, a board may be formed from one or more combinations of compositions and/or slurries. For example, two or more slurries can be combined to make one slurry that can be used to make a board. A powder composition may be prepared with some components, and other components can be combined with a liquid to form a slurry that, e.g., can be combined with the powder composition to form one slurry to make a board. A powder composition can be combined with a liquid (e.g., an aqueous solution, such as water) to form one slurry that can be used to make the boards. One slurry can be used to make a board that has a uniform, cementitious matrix throughout the board. For example, a board may include a solid material including a reacted mixture of a magnesium oxide, wollastonite, a phosphate salt, water, vermiculite, pumice, a fiber (e.g., a fiberglass fiber, a basalt fiber, and/or a carbon fiber), and/or perlite, casein, and other components, such as additional retarders that can be added as another component. A board may include a solid material including a reacted mixture of a magnesium oxide, wollastonite, a sulfate salt (e.g., magnesium sulfate), water, and, in some embodiments, other components described herein, such as, but not limited to, perlite, citric acid, ethanol, lauric acid, stearic acid, and/or a metal stearate. A board may include a solid material including a reacted mixture of a magnesium oxide, wollastonite, a chloride salt (e.g., magnesium chloride), water, and, in some embodiments, other components described herein, such as, but not limited to, perlite, citric acid, ethanol, a lauric acid, a stearic acid, and/or a metal stearate.

In at least one embodiment, a board may include layers that include the same or a different material that is in solid form after curing or setting. For example, a board may include one layer of the same material that, e.g., includes magnesium oxide, wollastonite, a phosphate salt, a sulfate salt, and/or a chloride salt, and other components. A board may include one layer that includes a solid material including a reacted mixture of a magnesium oxide, wollastonite, a phosphate salt, water, vermiculite, pumice, a fiber (e.g., a fiberglass fiber, a basalt fiber, and/or a carbon fiber), and/or perlite, casein, and other components, such as additional retarders that can be added as another component. A board may include a solid material including a reacted mixture of a magnesium oxide, wollastonite, a sulfate salt (e.g., magnesium sulfate), water, and, in some embodiments, other components described herein, such as, but not limited to, perlite, citric acid, ethanol, lauric acid, stearic acid, and/or a metal stearate. A board may include a solid material including a reacted mixture of a magnesium oxide, wollastonite, a chloride salt (e.g., magnesium chloride), water, and, in some embodiments, other components described herein, such as, but not limited to, perlite, citric acid, ethanol, lauric acid, stearic acid, and/or a metal stearate. This layer may form a core layer for the board, which may be between two external layers that have a different composition. For example, one or more external layers that can form one more exterior surfaces of the board can exhibit integral water resistance (e.g., no observable water absorption throughout a thickness of a board), include water repellent additives described herein (e.g., siloxane), and/or different concentrations of one or more of the composition materials as compared to the core layer. One of ordinary skill in the art will appreciate that different combinations, ratios, and concentrations can be used to make the boards using compositions and/or slurries described elsewhere herein.

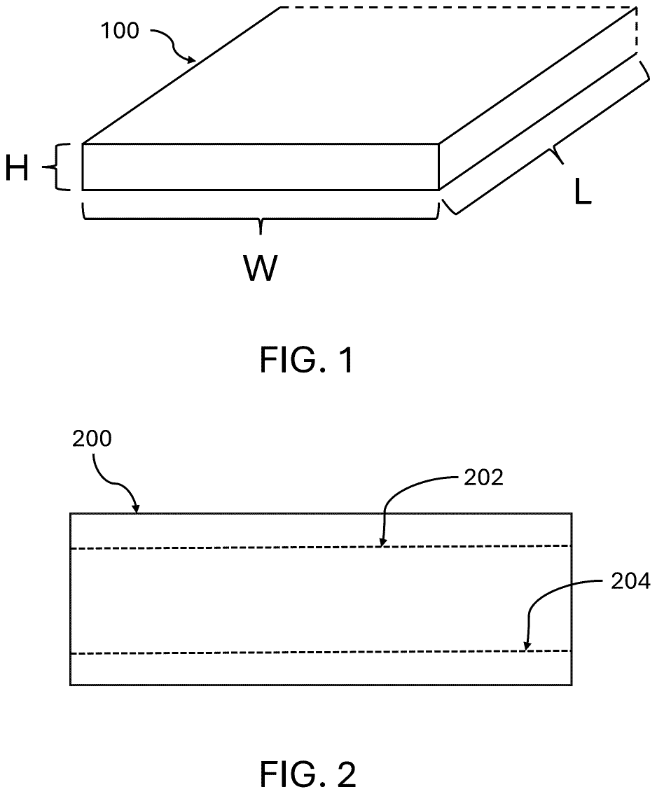

In at least one embodiment, FIG. 1 shows a board 100 having a height (H), width (W), and length (L), in accordance with at least one embodiment. Example dimensions can include 8′×4′×¼″, 10′×4′×¼″, 12′×4′×¼″, 8′×4′×⅜″, 10′×4′×⅜″, 12′×4′×⅜″, 8′×4′×½″, 10′×4′×½″, 12′×4′×½″, 8′×4′×¾″, 10′×4′×¾″, 12′×4′×¾″, 8′×5′×¼″, 10′×5′×¼″, 12′×5′×¼″, 8′×5′×⅜″, 10′×5′×⅜″, 12′×5′×⅜″, 8′×5′×½″, 10′×5′×½″, 12′×5′×½″, 8′×5′×¾″, 10′×5′×¾″, and 12′×5′×¾″. The boards described herein are advantageous, for example, as being lightweight, strong, intrinsically non-corrosive, and intrinsically resistant to fire and water, and amenable to large-scale production. The boards can also be void or free of crystalline silica (SiO₂), which, e.g., can avoid unnecessary health risks and provide a lighter-weight board. For example, the boards and cured slurries can include 0% of crystalline silica (SiO₂).

In at least one embodiment, boards and cured slurries described herein, for example, can meet non-combustible criteria in accordance with ASTM E136-24c, Standard Test Method for Assessing Combustibility of Materials Using a Vertical Tube Furnace at 750° C. For example, a combination of magnesium oxide and wollastonite as described herein can provide an ability to form solid materials that are not combustible. For example, cured slurries and boards described herein (e.g., including MgO, wollastonite, and at least one a phosphate salt, a sulfate salt, and a chloride salt) can exhibit a temperature rise of less than 30 degrees Celsius, less than about 25 degrees Celsius, less than about 20 degrees Celsius, less than about 15 degrees Celsius, between about 15 to less than about 30 degrees Celsius, between about 20 to less than about 30 degrees Celsius, or between about 25 to less than about 30 degrees Celsius, when exposed to a temperature rise to a surrounding temperature of 750° C. in accordance with the standards methods provided in ASTM E136-24c, Standard Test Method for Assessing Combustibility of Materials Using a Vertical Tube Furnace at 750° C. An example aspect of the cured slurries and boards described further herein includes inherent water resistance and lowered risks of deleterious effects such as water absorption, deliquescence, freeze-thaw damage, and corrosivity.

In at least one embodiment, cured slurries and boards described further herein can have water penetration resistance (e.g., integral water resistance where, for example, there is no observable water absorption throughout a thickness of a board) that meets or exceeds criteria established by ASTM E331-00(2023), Standard Test Method for Water Penetration of Exterior Windows, Skylights, Doors, and Curtain Walls by Uniform Static Air Pressure Difference, which includes an absence of water penetration when subjected to 15-minute calibrated water spraying under differential pressure of 2.86 pounds per square foot (psf). Building codes recognize different methods for demonstrating water resistance. One example method involves water ponding in which one inch of water is held against the intended barrier for a minimum of 2 hours. Conditions of acceptance shall be that no water shall transmit through the membrane over the designated test period. Ponding can exceed the requirements established by ASTM E331-00(2023), Standard Test Method for Water Penetration of Exterior Windows, Skylights, Doors, and Curtain Walls by Uniform Static Air Pressure Difference. For example, ASTM E331-00(2023) employs a differential pressure of 2.86 pounds per square foot (psf) for a test duration of 15 minutes. Ponding can use a test pressure of 5.2 psf for a test duration of at least 2 hours. In some embodiments, a five-inch water column can apply a test hydrostatic pressure of 26 pounds per square foot (psf), which is over 9 times greater than code-accepted requirements employed by ASTM E331-00(2023), Standard Test Method for Water Penetration of Exterior Windows, Skylights, Doors, and Curtain Walls by Uniform Static Air Pressure Difference for testing water resistance. The test duration can be for different durations, e.g., about 1 hour, about 5 hours, and, in some embodiments, about 24 hours, which is 96 times longer than the 15-minute exposure used by ASTM E331-00(2023). As shown, for example, in the examples below, cured slurries and/or boards described further herein show water penetration resistance under the water column testing conditions.

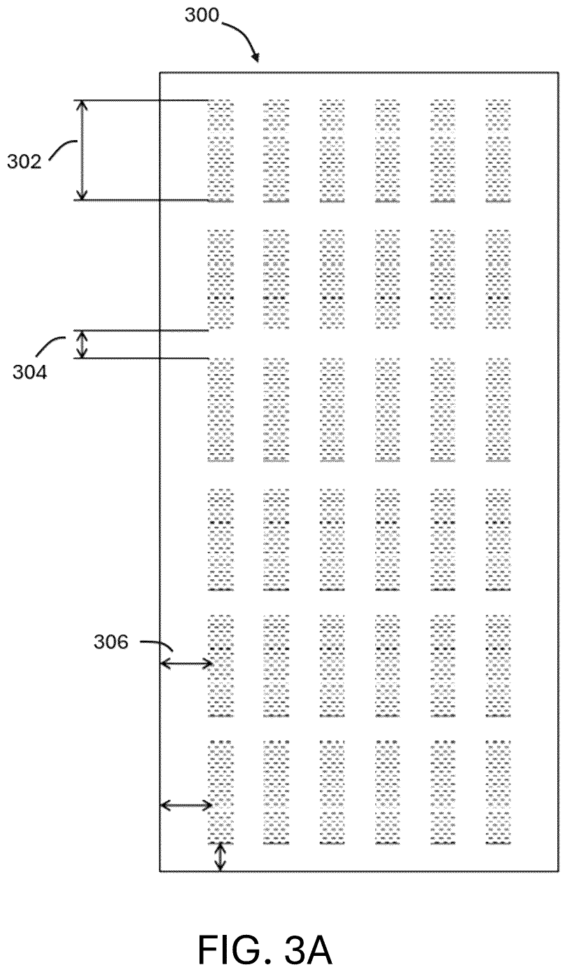

In at least one embodiment, the boards or other solid materials described further herein can include any number of layered structures, such as a structurally rigid layered structure of material, that can include material different from the composition of the board. Layered structures can be included in the board for different purposes, such as to increase flexural strength, improved impact resistance, and/or crack resistance of the board. A layered structure can include a mesh layered structure, which, in some embodiments, can include square, circular, and/or rectangular holes in a sheet material. A layered structure, such as a mesh layered structure, may include fiberglass, basalt mesh, Kevlar, or any combination thereof. A board may include one mesh layered structure. A board can include two (e.g., mesh) layered structures. A board can include three layered structures and so on. FIG. 2 shows a board 200 that includes two layered structures 202, 204. Layered structure 202 and layered structure 204 can be positioned near sides or outer surfaces of the board (e.g., such that a mesh does not extend beyond an edge or face of a board or the mesh can extend beyond an edge of the board). For example, a layered structures can be positioned within about ¼ inch from a side of the board. A layered structure may be positioned within about ⅛ inch from a side of the board. A layered structure can be positioned within about 1/16 inch from a side of the board. A layered structure can be positioned within about 1/32 inch from a side of the board. A layered structure can be positioned within about 1/64 inch from a side of the board. A first layered structure may be positioned near a first outer surface of the board and a second layered structure may be positioned at a second outer surface of the board. A layered structure can have any thickness, e.g., to further a purpose and/or property of the layered structure in the board. For example, a layered structure can have a thickness of about 5 to 10 mm, about 6 to 10 mm, about 7 to 10 mm, about 8 to 10 mm, and about 9 to 10 mm.

In at least one embodiment, the boards and other solid materials described herein can include an integral drainage surface. An integral drainage surface of the board can include, e.g., where the surface of the board includes ridges, protrusions, or other relief patterns that can be formed using the molding processes described further herein. For example, the boards can include one or more surface features that can be used, e.g., for draining incidental water that enters behind façade cladding or other exterior building materials, which can, e.g., facilitate drying of the boards with displacement, gravity-induced drainage, and/or evaporation. The boards can be cast in any desired form with surface geometries to accommodate water drainage on an exterior face. The boards can include drainage spacing patterns. Patterns can include protrusions, ribs, dots, ridges, and other surface features that extend or protrude from a surface of a board. Protrusions, ribs, dots, ridges, and other surface features that extend or protrude from a surface of a board can be positioned in any pattern. For example, protrusions, ribs, dots, ridges, and other surface features can recess into the board relative to a surface plane of the board or other solid material. Protrusions, ribs, dots, ridges, and other surface features can extend away from the board relative to a surface plane of the board or other solid material. In some embodiments, protrusions that extend outward from the surface plane can be present with the recessed features that extend inward relative to the surface plane of the board.

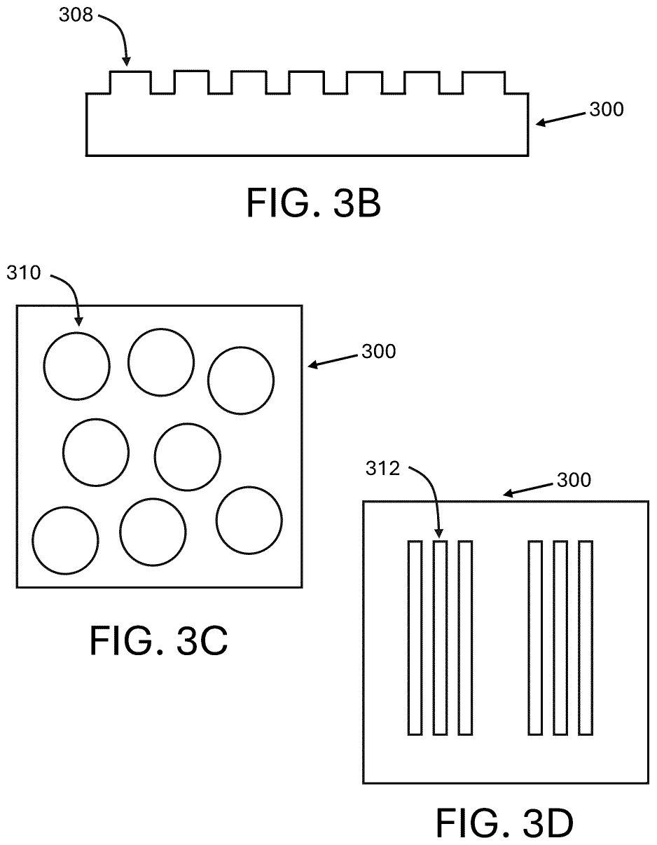

In at least one embodiment, FIG. 3A illustrates a solid material (e.g., a board) that can include a drainage spacing pattern. For example, board 300 can include an intermittent drainage relief pattern 302. Intermittent drainage relief pattern 302 can be offset by an intermittent spacing pattern 304. Intermittent drainage relief pattern 302 can be spaced from an edge, as shown by panel edge spacing 306. Any pattern is envisioned for the boards described herein, e.g., the relief pattern can be staggered to offer regular intervals of flat, smooth surfaces where panels abut or tie into other assembly components. Patterns can also be used to enhance reduction of water penetration by having spacing patterns designed for optimized tapes, self-adhered flashing, and liquid-applied flashing at panel joints and other interfaces. Patterns for the boards that can provide an integral drainage surface can achieve drainage efficiencies of 90% or greater per the standard method ASTM E2273-18, Standard Test Method for Determining the Drainage Efficiency of Exterior Insulation and Finish Systems (EIFS) Clad Wall Assemblies. As provided herein elsewhere, boards that include patterns can also have water penetration resistance that meets or exceed criteria established by ASTM E331-00(2023), Standard Test Method for Water Penetration of Exterior Windows, Skylights, Doors, and Curtain Walls by Uniform Static Air Pressure Difference, which includes an absence of water penetration when subjected to 15-minute calibrated water spraying under differential pressure of 2.86 pounds per square foot (psf).

In at least one embodiment, FIG. 3B illustrates an example cross-section view of the boards can be cast in any desired form with surface geometries to accommodate water drainage on an exterior face of a solid material. Boards or other solid materials can include drainage spacing patterns, e.g., as illustrated in FIGS. 3C and 3D. Patterns can include protrusions, ribs, dots, ridges, and other surface features that extend or protrude from a surface of a board. Protrusions, ribs, dots, ridges, and other surface features that extend or protrude from a surface of a board can be positioned in any pattern, e.g., a regular or irregular pattern. A surface geometry can be offset in any direction (e.g., in a direction extending perpendicular from a surface plane of a board) from any surface of a solid material, such as the board. Patterns can be higher, lower, and/or the same height as some portions of a board. For example, an edge of a board may be the same height as protrusions or other surface geometry patterns. It will be appreciated that protrusions or other patterns may be offset from other portions of the panels at any height that achieves a desired drainage efficiency.

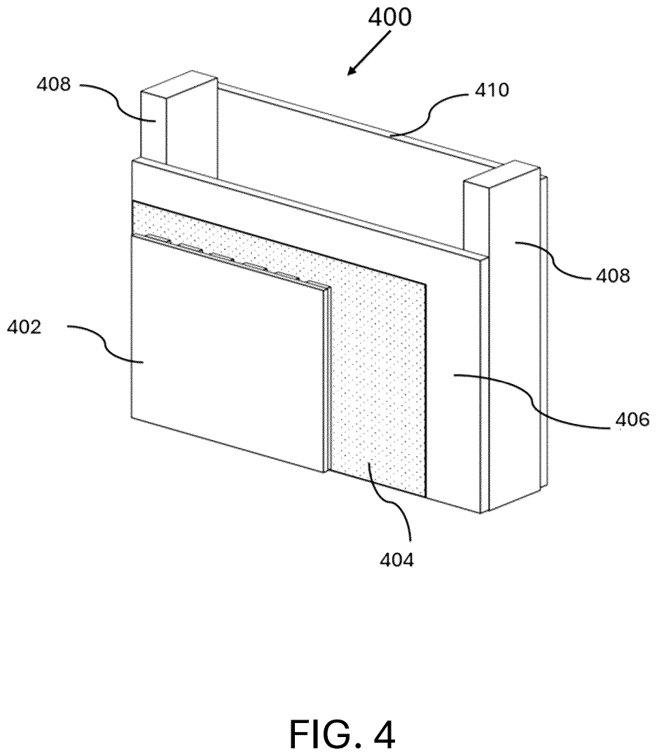

In at least one embodiment, FIG. 4 illustrates an example assembly of boards described herein as used, e.g., as a cladding and/or trim layer for construction with other components. Assembly 400, for example, can include a board 402 that can include protrusions (e.g., that extend inwardly or outwardly from the surface of the board) to improve water drainage efficiency. A board 402 can be positioned next to a water resistive barrier 404 that can be coupled to a sheathing 406. As shown, for example, protrusions of the board 402 (similar to shown in FIG. 3) can contact the water resistive barrier 404 and allow water to run down and in between board 402 and water resistive barrier 404. In an alternative, board 402 may interface with insulation or other materials that may be used in place or in addition to water resistive barrier 404. Wall framing 408 and an interior wallboard 410 can be used to hold board 402 in place when constructed. In some embodiments, board 402, water resistive barrier 404, and sheathing 406 can be coupled together before positioning onto wall framing 408. Integral drainage channels of board 402, and in some embodiments with integral water resistance properties of board 402 described herein, can facilitate water drainage and drying of some or all of the materials within assembly 400.

In at least one embodiment, methods are described to use a composition and/or a slurry described further herein to make a solid material, such as a board and/or a coating or other cured slurry material with a shape for a specific application. The compositions and slurries described herein and their respective components may be used as precursor or starting materials to form solid materials, such as boards, described herein. The methods can include combining (e.g., mixing or otherwise adding two or more components together to form one mixture) any of the materials in the compositions described further herein in any order. For example, the methods can include combining powdered forms of components described herein with a liquid (e.g., an aqueous solution) to form a slurry. Components as used herein can include the components in the compositions and/or slurries described herein (e.g., magnesium oxide, vermiculite, a retarder, and/or any other component described herein). The methods can include combining one component (e.g., magnesium oxide) with more of the same component (e.g., magnesium oxide) and/or another component (e.g., wollastonite). The methods can include combining one component (e.g., magnesium oxide) with one or more other components (e.g., wollastonite and an aqueous solution).

In at least one embodiment, the methods can include combining magnesium oxide, wollastonite, and/or phosphate salt. The methods can include combining phosphate salt (e.g., an acid phosphate salt, such as KH₂PO₄), vermiculite, pumice, a fiber (e.g., a fiberglass fiber, a basalt fiber, and/or a carbon fiber), and/or perlite, a biopolymer (e.g., casein), a liquid (e.g. water) with or without other materials, such as additional retarders (e.g., a retarder, such as citric acid) and/or additional materials, such as hydrophobic agents. The methods can include combining some materials together and then combining those combined materials with another material or a combination of other materials. For example, the methods can include combining magnesium oxide, wollastonite, a phosphate salt, and an aqueous solution (e.g., water) to form a slurry that can be combined with other components, such as vermiculite, pumice, a fiber (e.g., a fiberglass fiber, a basalt fiber, and/or a carbon fiber), perlite, or any combination thereof, as well as other materials, such as a biopolymer (e.g., casein).

In at least one embodiment, the methods can include combining magnesium oxide, wollastonite, and a sulfate salt. The methods can include combining magnesium oxide, wollastonite, a sulfate salt (e.g., a magnesium sulfate, such as MgSO₄·7H₂O or other hydrate form), and a liquid (e.g. water) with or without other materials, such as a filler, a retarder (e.g., citric acid and/or ethanol) and/or an additional material, such as lauric acid, stearic acid, and/or a metal stearate. The methods can include combining some materials together and then combining those combined materials with another material or a combination of other materials. For example, the methods can include combining magnesium oxide, wollastonite, a sulfate salt, and an aqueous solution (e.g., water) to form a slurry that can be combined with other components, such as at least one of vermiculite, pumice, a fiber (e.g., a fiberglass fiber, a basalt fiber, and/or a carbon fiber), perlite, or any combination thereof, as well as other components described herein (e.g., a retarder).

In at least one embodiment, the methods can include combining magnesium oxide, wollastonite, and a chloride salt. The methods can include combining magnesium oxide, wollastonite, a chloride salt (e.g., a magnesium chloride, such as MgCl₂·6H₂O or other hydrate form), and a liquid (e.g. water) with or without other materials, such as a filler, a retarder (e.g., citric acid and/or ethanol) and/or an additional material, such as lauric acid, stearic acid, and/or a metal stearate. The methods can include combining some materials together and then combining those combined materials with another material or a combination of other materials. For example, the methods can include combining magnesium oxide, wollastonite, a chloride salt, and an aqueous solution (e.g., water) to form a slurry that can be combined with other components, such as at least one of vermiculite, pumice, a fiber (e.g., a fiberglass fiber, a basalt fiber, and/or a carbon fiber), perlite, or any combination thereof, as well as other components described herein (e.g., a retarder).

In at least one embodiment, combinations (e.g., mixtures) of the various materials can be formed into a slurry or other viscous combination of solids (e.g., that are partially, fully, or not dissolved in a liquid) and a liquid (e.g., an aqueous solution, such as water) that can be poured, injected, extruded, sprayed or otherwise provided into a mold to be shaped into a solid material, e.g., a board. The methods may include forming a board (e.g., using casting) such that the board includes smooth surfaces on some or all sides of the panel. For example, opposing sides of the board with the highest surface area may both be smooth. Smooth surfaces on the boards can be formed, e.g., by providing (such as, pouring) a slurry described herein into vertically-oriented cassettes or chambers or, e.g., by providing (such as, pouring) a slurry described herein horizontally and placing another solid surface against an exposed side of the slurry, or otherwise using physical or mechanical methods to produce a smooth surface, such as using differential air pressure, sound waves, and/or vibration. One or more sides of the cassettes, chambers, and other mold or casting surfaces used can include hydrophobic or superhydrophobic coatings or materials to, e.g., enhance smoothness of the surfaces of the molded or cast materials, such as the boards. The methods can be used to form boards having two smooth, co-planar faces (e.g., using a five or six-sided mold), which can remove a need to sand one or more surfaces of the board. The methods can include forming boards with one smooth surface and a rougher surface that may need to sanded or otherwise smoothed. For example, a slurry may be poured horizontally into a mold that has a smooth surface, and an opposing side of the of the board remains open to air or a space such that curing or setting of the board on the opposing side may be rougher than the smooth, molded surface. The methods can include sanding or other methods to smooth the rougher side of the board.

In at least one embodiment, methods can include combining a magnesium oxide, wollastonite, and an aqueous solution (e.g., water). The methods may include combining phosphate salt (e.g., an acid phosphate salt, such as KH₂PO₄) with the magnesium oxide, the wollastonite, and the aqueous solution (e.g., water). The methods can include combining vermiculite and/or perlite with a phosphate salt (e.g., an acid phosphate salt, such as KH₂PO₄), a magnesium oxide, wollastonite, and the aqueous solution (e.g., water). The methods can include pouring, injecting, or otherwise providing a first quantity of a slurry comprising magnesium oxide, the wollastonite, water, the phosphate salt, and vermiculite into a mold. The methods can include forming a coating, a board, or other shape using, e.g., a mold or other molding process, such casting, injection molding, and/or compression molding. Additional components, such as a biopolymer (e.g., casein), retarders, fillers, or other composition components described herein can be combined with any of the combined mixtures produced during the methods.

In at least one embodiment, the methods can include positioning a first (e.g., mesh) layered structure over at least a portion of the first quantity of the slurry that was poured or otherwise provided to the mold. The methods can include providing (e.g., pouring) a second quantity of the slurry comprising magnesium oxide, wollastonite, water, the phosphate salt, a sulfate salt, and/or a chloride salt, and, in some embodiments, a filler (e.g., vermiculite and/or perlite) into the mold. The methods can include positioning a second (e.g., mesh) layered structure over at least a portion of the second quantity of the slurry. The slurry may be one slurry. The slurry may include one slurry including any combination of the compositions described herein. The slurry may include one slurry that includes magnesium oxide, wollastonite, water, phosphate salt (e.g., an acid phosphate salt, such as KH₂PO₄), a sulfate salt, and/or a chloride salt, and, in some embodiments, a biopolymer (e.g., casein) and a filler (e.g., vermiculite and/or perlite).

In at least one embodiment, methods may include making a coating, a board, or other shape that can include layers of different materials. For example, one layer may include a solid material including a reacted mixture of a magnesium oxide, wollastonite, a phosphate salt, a sulfate salt, and/or a chloride salt, water, vermiculite and/or perlite, casein, and other components, such as additional retarders and/or materials, such as hydrophobic agents. This layer may form a core layer for the board, which may be sandwiched between two external layers that have a different composition. For example, one or more external layers that can form one more exterior surfaces of the board can include water repellent additives described herein (e.g., siloxane) and/or different concentrations of one or more of the composition materials as compared to the core layer. Patterned drainage surfaces can be cast on an exterior face of a board and an interior face can include a flat surface, e.g., to provide a planar interface with wall framing members or other substrates. Drainage can be facilitated by the addition of hydrophobic admixtures that repeal surface water and impedes water absorption. These combined effects increase drainage efficiencies by encouraging the flow of bulk water and preventing absorption of latent droplets.

In at least one embodiment, methods described herein can further include pouring, injecting, or otherwise providing a slurry into a pre-formed mold that can include patterns and/or relief geometries for enhanced water drainage. As described above elsewhere, slurries including various components of the compositions described herein can be poured, injected, or otherwise provided to a mold that includes recessed portions that extrude from a surface of a board or other solid material where a slurry, for example, can fill the recessed portions and, when cured form, patterns (e.g., intermittent drainage patterns illustrated in FIGS. 3A-D). The methods can be used to make a board or other solid material that can include an integral drainage surface. An integral drainage surface of the board or solid material can include, e.g., where the surface of the board or other solid material includes ridges, protrusions, or other relief patterns that can be formed using the molding processes described further herein. For example, a board or another solid material can include one or more surface features that can be used, e.g., for draining incidental water that enters behind façade cladding or other exterior building materials, which can, e.g., facilitate drying of the boards with displacement, gravity-induced drainage, and/or evaporation. The boards or other solid material can be cast in any desired form with surface geometries to accommodate water drainage on an exterior face. The boards or other solid material can include drainage spacing patterns. Patterns can include protrusions, ribs, dots, ridges, and other surface features that extend or protrude from a surface of a board. Protrusions, ribs, dots, ridges, and other surface features that extend or protrude from a surface of a board or other solid material can be positioned in any pattern.

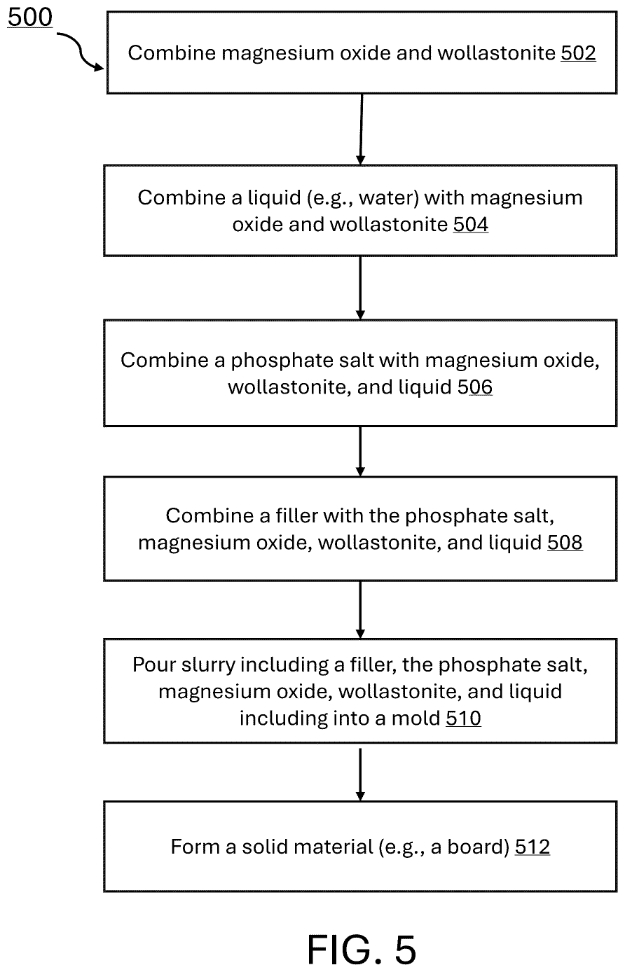

FIG. 5 shows a method 500 of making a board, in accordance with at least one embodiment. As shown in step or element 502, the methods may include combining magnesium oxide, wollastonite, and a liquid (e.g., an aqueous solution, such as water). As shown in step or element 504, the methods can include combining a phosphate salt (e.g., an acid phosphate salt) with the magnesium oxide, wollastonite, and liquid (e.g., an aqueous solution, such as water). As shown in step or element 506, the methods can include combining a filler (e.g., vermiculite and/or perlite) with the phosphate salt, magnesium oxide, wollastonite, and a liquid (e.g., an aqueous solution, such as water). As shown in step or element 508, the methods can include providing (e.g., pouring) a mixture, such as a slurry, including a filler (e.g., vermiculite and/or perlite), a phosphate salt, magnesium oxide, wollastonite, and a liquid (e.g., an aqueous solution, such as water) including into a mold. As shown in step or element 510, the methods can include forming a board that includes a filler (e.g., vermiculite and/or perlite), a phosphate salt, magnesium oxide, wollastonite, and a liquid (e.g., an aqueous solution, such as water). Forming the board or other solid material may include drying or curing the slurry at room temperature or any other temperature or conditions that allow the slurry to harden and form the board or other solid material. In at least one embodiment, curing conditions can include room temperature (e.g., about 65 F-70 F) and, e.g., a humidity level (e.g., about 80-90% relative humidity) for an initial time period, e.g., 12-24 hours. In some embodiments, curing conditions can include a temperature range between about 50-90 F and a humidity level about 50-95% relative humidity. In some embodiments, following an initial time period, panels can be removed e.g., from molds, and maintained at a temperature and humidity level (e.g., about 65-75 F and about 40-60% relative humidity) for a second time period (e.g., from about 7 to 28 days). In some embodiments, panels may be exposed during another time period at a different temperature and humidity levels (e.g., 50-90 F and 35-70% relative humidity). In at least one embodiment, a board or other solid material described further herein may be produced by the methods described further herein. The method shown in FIG. 5 can be used to make other solid materials or coating that have a desired shape. It will be appreciated that a chloride salt and/or a sulfate salt can be combined with a phosphate salt and used to make a board as described in FIG. 5.

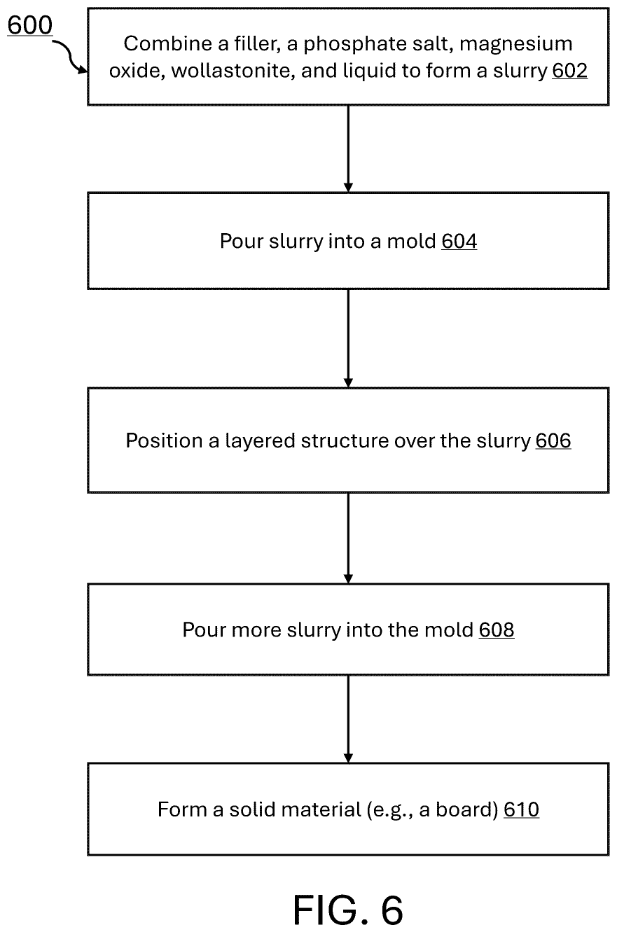

FIG. 6 shows a method 600 of making a board, in accordance with at least one embodiment. As shown in step or element 602, the methods can include combining a filler (e.g., vermiculite and/or perlite), a phosphate salt, magnesium oxide, wollastonite, and a liquid (e.g., an aqueous solution, such as water) to form a slurry. As shown in step or element 604, the methods can include providing (e.g., pouring) the slurry into a mold. As shown in step or element 606, the methods can include positioning a layer, such as a mesh layer, over the slurry. As shown in step or element 608, the methods can include providing (e.g., pouring) more slurry into the mold. The methods may include one or more steps of positioning a layered structure, such as a mesh layered structure, over the slurry and providing (e.g., pouring) more slurry into the mold. For example, steps or elements 606 and 608 can be repeated one or more times before step or element 610 to form the board. As shown in step or element 610, the methods can include forming a board that includes a filler (e.g., vermiculite and/or perlite), a phosphate salt, magnesium oxide, wollastonite, and a liquid (e.g., an aqueous solution, such as water). The method shown in FIG. 6 can be used to make other solid materials or coating that have a desired shape. Forming the board or other solid material may include drying or curing the slurry at room temperature or any other temperature or conditions that allow the slurry to harden and form the board or other solid material. In at least one embodiment, curing conditions can include room temperature (e.g., about 65 F-70 F) and, e.g., a humidity level (e.g., about 80-90% relative humidity) for an initial time period, e.g., 12-24 hours. In some embodiments, curing conditions can include a temperature range between about 50-90 F and a humidity level about 50-95% relative humidity. In some embodiments, following an initial time period, panels can be removed e.g., from molds, and maintained at a temperature and humidity level (e.g., about 65-75 F and about 40-60% relative humidity) for a second time period (e.g., from about 7 to 28 days). In some embodiments, panels may be exposed during another time period at a different temperature and humidity levels (e.g., 50-90 F and 35-70% relative humidity). It will be appreciated that a chloride salt and/or a sulfate salt can be combined with a phosphate salt and used to make a board as described in FIG. 6.

In at least one embodiment, the methods can include using magnesium oxide, e.g., as a starting or precursor material. A magnesium oxide can include MgO. A magnesium oxide may include different calcined forms of magnesium oxide. For example, magnesium oxide can be light-burned. A light-burned magnesium oxide can be produced from calcining temperatures of about 700-1100 degrees Celsius. A light-burned magnesium oxide may be produced from calcining temperatures of about 700-900 degrees Celsius. A light-burned magnesium oxide can be produced from calcining temperatures of about 700-800 degrees Celsius. In at least one embodiment, magnesium oxide can be hard-burned. A hard-burned magnesium oxide can be produced from calcining temperatures between about 1100-1400 degrees Celsius. In at least one embodiment, magnesium oxide can be dead-burned. A dead-burned magnesium oxide can be produced from calcining temperatures between greater than about 1400 degrees Celsius. In at least one embodiment, magnesium oxide can be calcined at temperatures less than about 700 degrees Celsius. A composition and/or slurry described further herein can include any combination of calcined forms of magnesium oxide (e.g., light-burned magnesium oxide and dead-burned magnesium oxide). Various methods can be used for calcining the magnesium oxide. For example, a furnace, kiln, or other heating device can be used to calcine the magnesium oxide. Magnesium oxide can be present in the compositions and/or slurries described herein at a percentage weight of the total weight of a composition and/or slurry described herein. A slurry that includes a liquid (e.g., an aqueous solution, such as water) can have a total formulation weight that includes a final combined weight of all components (e.g., powdered composition components and water together). A slurry that includes a liquid (e.g., an aqueous solution, such as water) can include, for example, magnesium oxide (e.g., light-burned magnesium oxide) ranging from about 13% to about 30% of a total weight of the slurry (e.g., 1.3 kg of MgO in a 10 kg slurry, or 13%), from about 15% to about 25% of a total weight of the slurry, from about 20% to about 25% of a total weight of the slurry, from about 25% to about 30% of a total weight of the slurry, from about 18% to about 20% of a total weight of the slurry, from about 22% to about 24% of a total weight of the slurry, and from about 18% to about 22% of a total weight of the slurry. In some embodiments, a slurry that includes a sulfate salt and a liquid (e.g., an aqueous solution, such as water) can include, for example, magnesium oxide ranging from about 20% to about 55% of a total weight of the slurry, from about 20% to about 40%, and from about 25% to about 35% of a total weight of the slurry. In some embodiments, a slurry that includes a chloride salt and a liquid (e.g., an aqueous solution, such as water) can include, for example, magnesium oxide ranging from about 20% to about 50% of a total weight of the slurry, from about 20% to about 40%, and from about 25% to about 30% of a total weight of the slurry.

In at least one embodiment, the methods can include using wollastonite, e.g., as a starting or precursor material. Wollastonite can include CaSiO₃. Wollastonite can include different grades (e.g., wollastonite from Vanderbilt Minerals, such as Vansil W-10 and W-20). Wollastonite may be used to modify working times for the compositions, slurries, and boards described further herein. For example, light-burned magnesium oxide can have increased reactivity, and existing retarders used in slowing the set or cure of existing cements can have limiting effect and are typically detrimental to strength properties when used in excess. In compositions, slurries, boards, etc., described herein, wollastonite can act as a retarder to provide longer working times that allow the slurry to be formed into shapes before hardening or becoming too viscous to be useful, e.g., to allow for making boards described further herein. Wollastonite may also be added to increase strength of the boards as well as increase dimensional stability, such as reducing cracking and/or warping, as described further herein. For example, increasing amounts of wollastonite in solid materials (e.g., boards) described herein can be used to increase flexural strength of the solid materials (e.g., boards). Wollastonite can be used to provide a flexural strength (MPa) of a solid material described herein (e.g., a board) of greater than about 10 MPa, greater than about 15 MPa, greater than about 20 MPa, greater than about 25 MPa, between about 10 MPa to about 15 MPa, between about 10 MPa to about 25 MPa, between about 15 MPa to about 20 MPa. Wollastonite can be used to reduce or eliminate warping of a solid material described herein (e.g., a board) including 0 mm of warping or bending over at least 1 foot of a dimension of a board having a width×height×length, 1 mm of warping or bending over at least 1 foot of a dimension of a board having a width×height×length, or 2 mm of warping or bending over at least 1 foot of a dimension of a board having a width×height×length. Wollastonite also can be used to reduce or eliminate deliquescence (e.g., surface droplets forming on the surface of a board) in the solid materials formed using a composition and/or slurry described further herein. For example, solid materials formed using a composition and/or slurry including wollastonite described further herein do not exhibit deliquescence, e.g., after at least 48 hours at about 35 degrees F. and about 90% relative humidity. Solid materials formed using a composition and/or slurry including wollastonite described further herein exhibited, for example, a free chloride percentage weight of less than about 4%. A slurry that includes a liquid (e.g., an aqueous solution, such as water) can, for example, include wollastonite (and, in some embodiments, a phosphate salt) ranging from about 5% to about 30% of a total weight of the slurry, from about 5% to about 20% of a total weight of the slurry, ranging from about 4% to about 18% of a total weight of the slurry (e.g., 0.4 kg of wollastonite in a 10 kg slurry, or 4%), from about 6% to about 16% of a total weight of the slurry, from about 8% to about 12% of a total weight of the slurry, from about 10% to about 16% of a total weight of the slurry, and from about 4% to about 10% of a total weight of the slurry. In some embodiments, a slurry that includes a sulfate salt and a liquid (e.g., an aqueous solution, such as water) can include, for example, wollastonite ranging from about 5% to about 30% of a total weight of the slurry, from about 5% to about 20%, and from about 7% to about 15% of a total weight of the slurry. In some embodiments, a slurry that includes a chloride salt and a liquid (e.g., an aqueous solution, such as water) can include, for example, wollastonite ranging from about 5% to about 30% of a total weight of the slurry, from about 5% to about 20%, and from about 5% to about 10% of a total weight of the slurry. In some embodiments, a total weight of a slurry used to form a solid material described herein can include at least about 5% weight of wollastonite, at least about 10% weight of wollastonite, at least about 15% weight of wollastonite, at least about 20% weight of wollastonite, and at least about weight of 25% wollastonite.

In at least one embodiment, the methods can include using the compositions and/or slurries, e.g., as a starting or precursor material that can include a ratio of wollastonite to magnesium oxide. A ratio of wollastonite to magnesium oxide can be greater than about 0.3 by weight (e.g., 0.6 kilograms of wollastonite to every 1 kilogram of magnesium oxide). A ratio of wollastonite to magnesium oxide may be greater than about 0.5 by weight. A ratio of wollastonite to magnesium oxide may be greater than about 0.6 by weight. A ratio of wollastonite to magnesium oxide can be greater than about 0.7 by weight. A ratio of wollastonite to magnesium oxide can be greater than about 0.8 by weight. A ratio of wollastonite to magnesium oxide can be greater than about 0.9 by weight. A ratio of wollastonite to magnesium oxide may be greater than about 1.0 by weight. A ratio of wollastonite to magnesium oxide can be greater than about 1.1 by weight. A ratio of wollastonite to magnesium oxide can be greater than about 1.2 by weight. A ratio of wollastonite to magnesium oxide can be between about 0.3 and 1.2 by weight. A ratio of wollastonite to magnesium oxide may be between about 0.5 and 1.2 by weight. A ratio of wollastonite to magnesium oxide can be between about 0.6 and 1.2 by weight. A ratio of wollastonite to magnesium oxide may be between about 0.6 to 1.1 by weight. A ratio of wollastonite to magnesium oxide can be between about 0.6 to 1.0 by weight. A ratio of wollastonite to magnesium oxide can be between about 0.6 to 0.9 by weight. A ratio of wollastonite to magnesium oxide can be between about 0.6 to 0.8 by weight. A ratio of wollastonite to magnesium oxide may be between about 0.6 to 0.7 by weight.

In at least one embodiment, the methods can include using a phosphate salt (e.g., an acid phosphate salt), e.g., as a starting or precursor material from compositions and/or slurries described further herein. A phosphate salt may include an acid phosphate salt. A phosphate salt may include a phosphoric acid (e.g., H₃PO₄), a polyphosphate (e.g., triphosphoric acid), a pyrophosphate (e.g., disodium pyrophosphate), an inorganic phosphate (e.g., KH₂PO₄), an organic phosphate (e.g., NH₄H₂PO₄ or a phosphonate), or any combination thereof. A phosphate salt can include a phosphoric acid (H₃PO₄). A phosphate salt can include ammonium dihydrogen phosphate (NH₄H₂PO₄). A phosphate salt may include monopotassium phosphate (KH₂PO₄), which can also be referred to as potassium dihydrogen phosphate. A phosphate salt may include any combination of phosphoric acid (H₃PO₄), ammonium dihydrogen phosphate (NH₄H₂PO₄), and/or monopotassium phosphate (KH₂PO₄). For example, phosphate salt can include phosphoric acid (H₃PO₄) and ammonium dihydrogen phosphate (NH₄H₂PO₄). Phosphate salt can include phosphoric acid (H₃PO₄) and a monopotassium phosphate (KH₂PO₄). A slurry that includes a liquid (e.g., an aqueous solution, such as water) can, for example, include a phosphate salt (e.g., KH₂PO₄) or a combination of two or more different phosphate salts ranging from about 20% to about 35% of a total weight of the slurry (e.g., 2 kg of phosphate salt in a 10 kg slurry, or 20%), from about 20% to about 25% of a total weight of the slurry, from about 25% to about 30% of a total weight of the slurry, from about 22% to about 28% of a total weight of the slurry, from about 24% to about 30% of a total weight of the slurry, and from about 26% to about 28% of a total weight of the slurry.

In at least one embodiment, the methods can include using compositions and/or slurries that include a weight ratio of magnesium oxide to phosphate salt (e.g., MgO:acid phosphate salt, such as KH₂PO₄) that may depend on the reactivity of the magnesium oxide. For example, light-burned magnesium oxide can be more reactive than hard-burned magnesium oxide. Higher weight ratios of magnesium oxide to acid phosphate salt may be used for hard-burned magnesium oxide as compared to light-burned magnesium oxide.

In at least one embodiment, the methods can include using compositions and/or slurries that can include a weight ratio of magnesium oxide to phosphate salt that can be used for more reactive forms of magnesium oxide, such as light-burned magnesium oxide. Compositions and/or slurries may include a weight ratio of magnesium oxide to phosphate salt (e.g., MgO:acid phosphate salt, such as KH₂PO₄) that is less than or equal to about 1.0. Compositions and/or slurries may include a weight ratio of magnesium oxide to phosphate salt (e.g., MgO:acid phosphate salt, such as KH₂PO₄) that is less than about 0.9. Compositions and/or slurries may include a weight ratio of magnesium oxide to phosphate salt (e.g., MgO:acid phosphate salt, such as KH₂PO₄) that is less than about 0.8. Compositions and/or slurries can include a weight ratio of magnesium oxide to phosphate salt (e.g., MgO:acid phosphate salt, such as KH₂PO₄) that is less than about 0.7. Compositions and/or slurries can include a weight ratio of magnesium oxide to phosphate salt (e.g., MgO:acid phosphate salt, such as KH₂PO₄) that is less than about 0.6. A composition and/or slurry can include a weight ratio of magnesium oxide to phosphate salt (e.g., MgO:acid phosphate salt, such as KH₂PO₄) that is between about 0.4 and 1.0. Compositions and/or slurries can include a weight ratio of magnesium oxide to phosphate salt (e.g., MgO:acid phosphate salt, such as KH₂PO₄) that is between about 0.5 and 1.0. Compositions and/or slurries may include a weight ratio of magnesium oxide to phosphate salt (e.g., MgO:acid phosphate salt, such as

KH₂PO₄) that is between about 0.6 and 1.0. Compositions and/or slurries can include a weight ratio of magnesium oxide to phosphate salt (e.g., MgO:acid phosphate salt, such as KH₂PO₄) that is between about 0.6 and 0.9. Compositions and/or slurries can include a weight ratio of magnesium oxide to phosphate salt (e.g., MgO:acid phosphate salt, such as KH₂PO₄) that is between about 0.6 and 0.8. Compositions and/or slurries may include a weight ratio of magnesium oxide to phosphate salt (e.g., MgO:acid phosphate salt, such as KH₂PO₄) that is between about 0.6 and 0.75.

In at least one embodiment, compositions and/or slurries can include a weight ratio of magnesium oxide to phosphate salt that can be used for less reactive forms of magnesium oxide, such as hard- or dead-burned magnesium oxide. Compositions and/or slurries can include a weight ratio of magnesium oxide to phosphate salt (e.g., MgO:acid phosphate salt, such as KH₂PO₄) that is greater than about 1.0. Compositions and/or slurries can include a weight ratio of magnesium oxide to phosphate salt (e.g., MgO:acid phosphate salt, such as KH₂PO₄) that is greater than about 1.2. Compositions and/or slurries can include a weight ratio of magnesium oxide to phosphate salt (e.g., MgO:acid phosphate salt, such as KH₂PO₄) that is greater than about 1.4. Compositions and/or slurries can include a weight ratio of magnesium oxide to phosphate salt (e.g., MgO:acid phosphate salt, such as KH₂PO₄) that is greater than about 1.6. Compositions and/or slurries can include a weight ratio of magnesium oxide to phosphate salt (e.g., MgO:acid phosphate salt, such as KH₂PO₄) that is greater than about 1.8. Compositions and/or slurries can include a weight ratio of magnesium oxide to phosphate salt (e.g., MgO:acid phosphate salt, such as KH₂PO₄) that is greater than about 2. Compositions and/or slurries can include a weight ratio of magnesium oxide to phosphate salt (e.g., MgO:acid phosphate salt, such as KH₂PO₄) that is greater than about 2.2. Compositions and/or slurries can include a weight ratio of magnesium oxide to phosphate salt (e.g., MgO:acid phosphate salt, such as KH₂PO₄) that is between about 1 and 2.2. Compositions and/or slurries can include a weight ratio of magnesium oxide to phosphate salt (e.g., MgO:acid phosphate salt, such as KH₂PO₄) that is between about 1.5 and 2.2. Compositions and/or slurries can include a weight ratio of magnesium oxide to phosphate salt (e.g., MgO:acid phosphate salt, such as KH₂PO₄) that is between about 1.8 and 2.2. Compositions and/or slurries can include a weight ratio of magnesium oxide to phosphate salt (e.g., MgO:acid phosphate salt, such as KH₂PO₄) that is between about 1.9 and 2.1.

In at least one embodiment, compositions and/or slurries used in the methods may include phosphate salt crystals of varied sizes and dimensions, such as rectangular or oblong in shape. Phosphate salt crystals (e.g., acid phosphate salt, such as KH₂PO₄) may be formed by grinding or pulverizing using, for example, a grinder or other equipment that can crush powder into smaller crystals. Smaller phosphate salt crystals (e.g., acid phosphate salt, such as KH₂PO₄) can result in dissociated ions of the salt in a slurry that can be formed into boards described further herein. Salt crystals that are not disassociated can remain in crystal form, which may be vulnerable to disassociation over time when exposed to water and that may weaken the boards. Disassociation of the smaller phosphate crystals (e.g., acid phosphate salt, such as KH₂PO₄) can increase strength and durability of the cementitious matrix and the board. An example aspect of a smaller crystal size (e.g., crystals having dimensions less than about 0.2 mm or smaller) includes increased working times for making the boards described further herein. A phosphate crystal (e.g., acid phosphate salt, such as KH₂PO₄) may have an irregular shape where one dimension of the crystal is longer than another dimension of the crystal. Phosphate salt crystals (e.g., acid phosphate salt, such as KH₂PO₄) can have dimensions of less than about 0.5 mm, 0.4 mm, 0.3 mm, 0.2 mm, or less than 0.1 mm, or less than 0.05 mm. Phosphate salt crystals (e.g., acid phosphate salt, such as KH₂PO₄) can have dimensions of less than about 0.05 mm×0.1 mm. Phosphate salt crystals (e.g., acid phosphate salt, such as KH₂PO₄) can have dimensions of between about 0.5 mm and 0.05 mm. Phosphate salt crystals (e.g., acid phosphate salt, such as KH₂PO₄) can have dimensions of between about 0.4 mm and 0.05 mm. Phosphate salt crystals (e.g., acid phosphate salt, such as KH₂PO₄) can have dimensions of between about 0.3 mm and 0.05 mm. Phosphate salt crystals (e.g., acid phosphate salt, such as KH₂PO₄) can have dimensions of between about 0.2 mm and 0.05 mm. Phosphate salt crystals (e.g., acid phosphate salt, such as KH₂PO₄) can have dimensions of between about 0.1 mm and 0.05 mm.

In at least one embodiment, the compositions and/or slurries used in the methods can also include fillers, such as vermiculite, pumice, a fiber (e.g., a fiberglass fiber, a basalt fiber, and/or a carbon fiber), perlite, or any combination thereof, e.g., as components in precursor or starting materials for making boards and/or cured slurries. Vermiculite and perlite (individually or combined), as well as, pumice, a fiber (e.g., a fiberglass fiber, a basalt fiber, and/or a carbon fiber) or any combination thereof, for example, can be used as a lightweight filler and crack propagation mitigant. The compositions can include vermiculite ((Mg,Fe²⁺,Fe³⁺)₃[(Al,Si)+O₁₀](OH)₂·4H₂O). The compositions can include perlite, which may include 70-75% silicon dioxide: SiO₂, 12-15% aluminum oxide: Al₂O₃, 3-4% sodium oxide: Na₂O, 3-5% potassium oxide: K₂O, 0.5-2% iron oxide: Fe₂O₃, 0.2-0.7% magnesium oxide: MgO, and 0.5-1.5% calcium oxide: CaO, and 3-5% combined water (H₂O). The compositions can include vermiculite and perlite. A slurry that includes a liquid (e.g., an aqueous solution, such as water) can, for example, include a filler (e.g., vermiculite, perlite, pumice, a fiber (e.g., a fiberglass fiber, a basalt fiber, and/or a carbon fiber), or a combination thereof) ranging from about 3% to about 10% of a total weight of the slurry (e.g., 0.3 kg of a filler in a 10 kg slurry, or 3%), from about 4% to about 10% of a total weight of the slurry, from about 5% to about 8% of a total weight of the slurry, from about 8% to about 10% of a total weight of the slurry, from about 3% to about 5% of a total weight of the slurry, and from about 4% to about 6% of a total weight of the slurry. In some embodiments, a slurry that includes a sulfate salt and a liquid (e.g., an aqueous solution, such as water) can include, for example, a filler ranging from about 0.1% to about 9% of a total weight of the slurry, from about 2% to about 7%, and from about 2% to about 4% of a total weight of the slurry. In some embodiments, a slurry that includes a chloride salt and a liquid (e.g., an aqueous solution, such as water) can include, for example, a filler ranging from about 0.1% to about 9% of a total weight of the slurry, from about 1% to about 7%, and from about 3% to about 7% of a total weight of the slurry.

In at least one embodiment, the compositions and/or slurries used in the methods can also include a biopolymer. The biopolymer can include casein. The compositions may include casein to form air bubbles and/or pores in the boards described further herein, which can, for example, add flame retardance properties and/or impart matrix uniformity, improved strength and greater water resistance. Other biopolymers may be included in the compositions for a variety of purposes, and other biopolymers can include fatty acids, chitin, chitosan, gum Arabic, guar gum, carboxymethyl cellulose, citric acid, sodium alginate, xanthan gum, or any combination thereof. A slurry that includes a liquid (e.g., an aqueous solution, such as water) can, for example, include a biopolymer (e.g., one type of biopolymer, such as casein) ranging from about 0.1% to about 1.2% of a total weight of the slurry (e.g., 0.1 kg of a filler in a 10 kg slurry, or 1%), from about 0.2% to about 1% of a total weight of the slurry, from about 0.2% to about 0.8% of a total weight of the slurry, from about 0.2% to about 0.5% of a total weight of the slurry, and from about 0.5% to about 1% of a total weight of the slurry. For a combination of two or more biopolymers (e.g., casein and chitin), percentages may include a sum of one biopolymer plus another biopolymer (e.g., casein may be present at a percentage of 1% of a total weight of the slurry and chitin may be present at a percentage of 1% of a total weight of the slurry to provide a combined percentage of biopolymers of 2%). A slurry that includes a liquid (e.g., an aqueous solution, such as water) can, for example, include a combination of two or more biopolymers (e.g., casein and chitin) ranging from about 0.2% to about 2.4% of a total weight of the slurry, from about 0.4% to about 2% of a total weight of the slurry, from about 0.4% to about 1.6% of a total weight of the slurry, from about 0.4% to about 1% of a total weight of the slurry, and from about 1% to about 2% of a total weight of the slurry.

In at least one embodiment, the compositions and/or slurries used in the methods may include additional retarders that may be used to increase a working time for making the boards described further herein. Retarders can include borax, citric acid, boric acid, ethanol, methanol, sodium alginate, glacial acetic acid, Lignosulfonates, sodium tripolyphosphate, or any combination thereof. A slurry that includes a liquid (e.g., an aqueous solution, such as water) can, for example, include a retarder (e.g., one type of retarder, such as borax) ranging from about 0.2% to about 2% of a total weight of the slurry (e.g., 0.2 kg of borax in a 10 kg slurry, or 2%), from about 0.2% to about 1.5% of a total weight of the slurry, from about 0.6% to about 1.1% of a total weight of the slurry, from about 0.7% to about 1.4% of a total weight of the slurry, from about 0.5% to about 1.5% of a total weight of the slurry, and from about 0.2% to about 1% of a total weight of the slurry. For a combination of two or more retarders (e.g., borax and citric acid), percentages may include a sum of one retarder plus another retarder (e.g., borax acid may be present at a percentage of 1% of a total weight of the slurry and citric acid may be present at a percentage of 1% of a total weight of the slurry to provide a combined percentage of retarders of 2%). A slurry that includes a liquid (e.g., an aqueous solution, such as water) can, for example, include a combination of two or more retarders (e.g., borax and citric acid) ranging from about 0.4% to about 4% of a total weight of the slurry (e.g., 0.4 kg of borax and citric acid combined in a 10 kg slurry, or 4%), from about 0.4% to about 3% of a total weight of the slurry, from about 1.2% to about 2.2% of a total weight of the slurry, from about 1.4% to about 2.8% of a total weight of the slurry, from about 1% to about 3% of a total weight of the slurry, and from about 0.4% to about 2% of a total weight of the slurry. In some embodiments, a slurry that includes a sulfate salt and a liquid (e.g., an aqueous solution, such as water) can include, for example, a retarder (e.g., citric acid) ranging from about 0.1% to about 5% of a total weight of the slurry, from about 2% to about 4% of a total weight of the slurry, from about 0.1% to about 1% of a total weight of the slurry, and from about 0.2% to about 0.3% of a total weight of the slurry. In some embodiments, a slurry that includes a chloride salt and a liquid (e.g., an aqueous solution, such as water) can include, for example, a retarder ranging from about 0.1% to about 5% of a total weight of the slurry, from about 2% to about 4% of a total weight of the slurry, from about 0.1% to about 1% of a total weight of the slurry, and from about 0.2% to about 0.3% of a total weight of the slurry. In some embodiments, a slurry that includes a liquid (e.g., an aqueous solution, such as water) and a sulfate and/or chloride salt can, for example, include a combination of two or more retarders (e.g., ethanol and citric acid) ranging from about 0.1% to about 6% of a total weight of the slurry (e.g., 0.4 kg of ethanol and citric acid combined in a 10 kg slurry, or 4%), from about 0.7% to about 3.3% of a total weight of the slurry, from about 0.5% to about 4% of a total weight of the slurry, and from about 1% to about 3% of a total weight of the slurry.

In at least one embodiment, the compositions and/or slurries described further herein used in the methods can also include materials to change water resistance, water repellency, and/or hydrophobic properties of the compositions, slurries, and/or boards described herein. Additional materials can include a hydrophobic agent (e.g., a siloxane, a silane, acrylics, and a silicone modified acrylic), a fatty acid (e.g. stearic acid, lauric acid, caprylic, oleic, and capric acids), a wax emulsion (e.g. ethoxylated sorbitan monostearate or sorbitan monostearate), a metal stearate (e.g. calcium stearate, magnesium stearate, and zinc stearate), a densifier (e.g. fly ash, metakaolin, rice husk ash, sunflower ash, slag, silica fume, nanoSiO₂, nano-Al₂O₃, nano-Fe₂O₃, and fluorosilicate-based admixtures), a crystalline admixture (e.g. sodium acetate), and any combinations thereof. A slurry that includes a liquid (e.g., an aqueous solution, such as water) can, for example, include an additional material (e.g., one type of hydrophobic agent or fatty acid (e.g., a lauric acid)) ranging from about 0.2% to about 1.1% of a total weight of the slurry, from about 0.3% to about 1% of a total weight of the slurry, from about 0.4% to about 0.8% of a total weight of the slurry, from about 0.4% to about 0.6% of a total weight of the slurry, and from about 0.2% to about 0.4% of a total weight of the slurry. A slurry that includes a liquid (e.g., an aqueous solution, such as water) can, for example, include a combination of two or more additional materials (e.g., a hydrophobic agent and a fatty acid (e.g., a lauric acid)) ranging from about 0.4% to about 2.2% of a total weight of the slurry, from about 0.6% to about 2% of a total weight of the slurry, from about 0.8% to about 1.6% of a total weight of the slurry, from about 0.8% to about 1.2% of a total weight of the slurry, and from about 0.4% to about 0.8% of a total weight of the slurry. In some embodiments, a slurry that includes a sulfate salt and a liquid (e.g., an aqueous solution, such as water) can include, for example, an additional material (e.g., lauric acid, stearic acid, or a metal stearate) ranging from about 0.2% to about 2% of a total weight of the slurry, from about 0.3% to about 1% of a total weight of the slurry, from about 0.2% to about 1.5% of a total weight of the slurry, and from about 0.5% to about 2% of a total weight of the slurry. In some embodiments, a slurry that includes a chloride salt and a liquid (e.g., an aqueous solution, such as water) can include, for example, an additional material (e.g., lauric acid, stearic acid, or a metal stearate) ranging from about 0.2% to about 2% of a total weight of the slurry, from about 0.3% to about 1% of a total weight of the slurry, from about 0.2% to about 1.5% of a total weight of the slurry, and from about 0.5% to about 2% of a total weight of the slurry. In some embodiments, a slurry that includes a liquid (e.g., an aqueous solution, such as water) and a sulfate and/or chloride salt can, for example, include a combination of two or more additional materials (e.g., lauric acid and stearic acid or a metal stearate) ranging from about 0.4% to about 4% of a total weight of the slurry (e.g., 0.4 kg of ethanol and citric acid combined in a 10 kg slurry, or 4%) and from about 0.6% to about 2% of a total weight of the slurry, and from about 1% to about 4% of a total weight of the slurry.

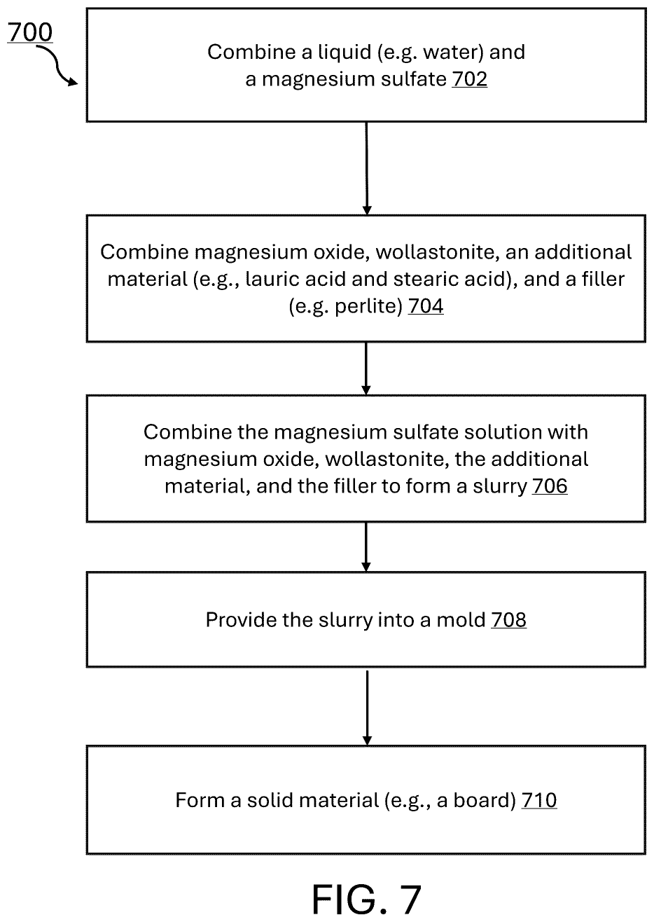

FIG. 7 shows a method 700 of making a board, in accordance with at least one embodiment. As shown in element 702, the methods may include combining a liquid (e.g., an aqueous solution, such as water) with a sulfate salt (e.g., MgSO₄). A retarder and/or other components, such as citric acid, for example, may also be included with the liquid and sulfate salt. As shown in element 704, the methods can include combining magnesium oxide, wollastonite, an additional material (e.g., lauric acid, stearic acid, and/or a metal stearate), and a filler (e.g., perlite), and/or other components. As shown in element 706, the methods can include the solution from element 702 with the components in element 704 to form a slurry. As shown in element 708, the methods can include providing (e.g., pouring) a mixture, such as a slurry, including liquid, sulfate salt, magnesium oxide, wollastonite, an additional material (e.g., a lauric acid, a stearic acid, and/or a metal stearate), and a filler into a mold. As shown in element 710, the methods can include forming a solid material (e.g., a board) that includes a filler (e.g., vermiculite and/or perlite), a sulfate salt, magnesium oxide, wollastonite, and a liquid (e.g., an aqueous solution, such as water). Forming the board or other solid material may include drying or curing the slurry at room temperature or any other temperature or conditions that allow the slurry to harden and form the board or other solid material. In at least one embodiment, curing conditions can include room temperature (e.g., about 65 F-70 F) and, e.g., a humidity level (e.g., about 80-90% relative humidity) for an initial time period, e.g., 12-24 hours. In some embodiments, curing conditions can include a temperature range between about 50-90 F and a humidity level about 50-95% relative humidity. In some embodiments, following an initial time period, panels can be removed e.g., from molds, and maintained at a temperature and humidity level (e.g., about 65-75 F and about 40-60% relative humidity) for a second time period (e.g., from about 7 to 28 days). In some embodiments, panels may be exposed during another time period at a different temperature and humidity levels (e.g. 50-90 F and 35-70% relative humidity). In at least one embodiment, a board or other solid material described further herein may be produced by the methods described further herein. The method shown in FIG. 7 can be used to make other solid materials or coating that have a desired shape. It will be appreciated by one of ordinary skill in the art that other components (e.g., a biopolymer) can be readily included, and the order of the steps is not limited to those described in FIG. 7. Furthermore, one of ordinary skill in the art will readily appreciate that the components (e.g., a filler, a biopolymer, an additional material) and the ranges (e.g., percent weight of the total weight of the slurries) described elsewhere herein can be used with methods of making chloride salt compositions, slurries, and/or solid materials (e.g., boards or other solid cementitious materials). It will be appreciated that a chloride salt can be combined with a sulfate salt and used to make a board including a chloride salt and a sulfate salt as described in FIG. 7.

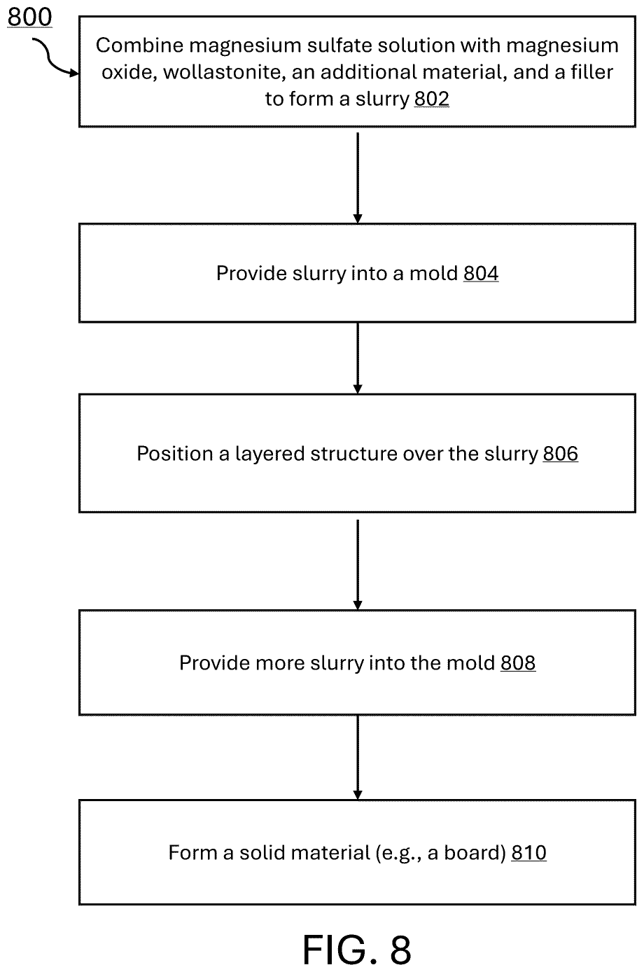

FIG. 8 shows a method 800 of making a board, in accordance with at least one embodiment. As shown in element 802, the methods can include combining a filler (e.g., vermiculite, pumice, a fiber (e.g., a fiberglass fiber, a basalt fiber, and/or a carbon fiber), perlite, or any combination thereof), a sulfate salt, magnesium oxide, wollastonite, and a liquid (e.g., an aqueous solution, such as water) to form a slurry. As shown in element 804, the methods can include providing (e.g., pouring) the slurry into a mold. As shown in element 806, the methods can include positioning a layer, such as a mesh layer, over the slurry. As shown in element 808, the methods can include providing (e.g., pouring) more slurry into the mold. The methods may include one or more aspects of positioning a layered structure, such as a mesh layered structure, over the slurry and providing (e.g., pouring) more slurry into the mold. For example, steps 806 and 808 can be repeated one or more times before step 810 to form the board. As shown in step 810, the methods can include forming a board that includes a filler (e.g., vermiculite, pumice, a fiber (e.g., a fiberglass fiber, a basalt fiber, and/or a carbon fiber), perlite, or any combination thereof), a sulfate salt, magnesium oxide, wollastonite, and a liquid (e.g., an aqueous solution, such as water). The method shown in FIG. 8 can be used to make other solid materials or coating that have a desired shape. It will be appreciated by one of ordinary skill in the art that other components (e.g., a fatty acid or other additional materials) can be readily included, and the order of the steps is not limited to those described in FIG. 8. Furthermore, one of ordinary skill in the art will readily appreciate that the components (e.g., a filler, a biopolymer, an additional material) and the ranges (e.g., percent weight of the total weight of the slurries) described elsewhere herein can be used with methods of making chloride salt compositions, slurries, and/or solid materials (e.g., boards or other solid cementitious materials). Forming the board or other solid material may include drying or curing the slurry at room temperature or any other temperature or conditions that allow the slurry to harden and form the board or other solid material. In at least one embodiment, curing conditions can include room temperature (e.g., about 65 F-70 F) and, e.g., a humidity level (e.g., about 80-90% relative humidity) for an initial time period, e.g., 12-24 hours. In some embodiments, curing conditions can include a temperature range between about 50-90 F and a humidity level about 50-95% relative humidity. In some embodiments, following an initial time period, panels can be removed e.g., from molds, and maintained at a temperature and humidity level (e.g., about 65-75 F and about 40-60% relative humidity) for a second time period (e.g., from about 7 to 28 days). In some embodiments, panels may be exposed during another time period at a different temperature and humidity levels (e.g., 50-90 F and 35-70% relative humidity). It will be appreciated that a chloride salt can be combined with a sulfate salt and used to make a board as described in FIG. 8.

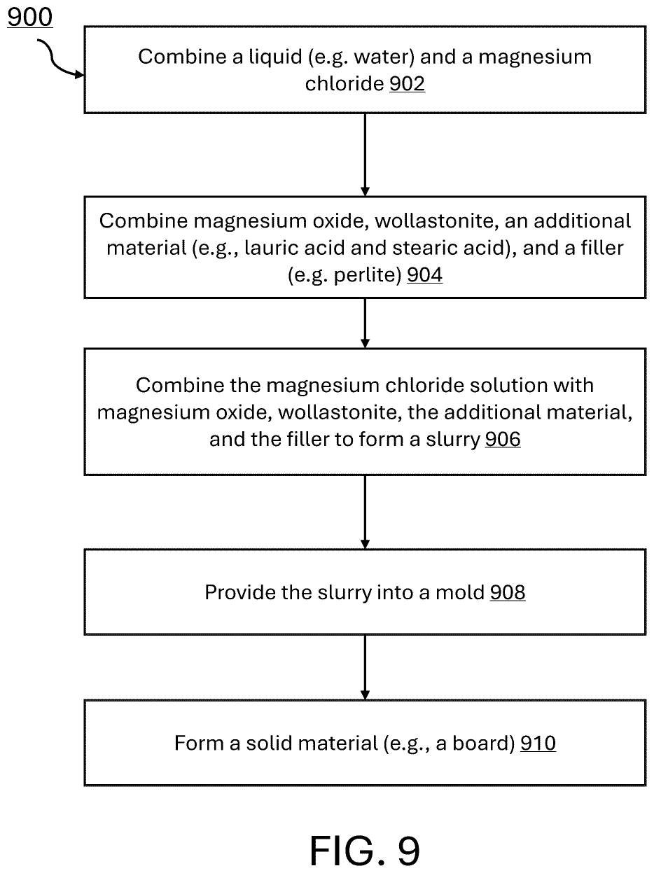

FIG. 9 shows a method 900 of making a board, in accordance with at least one embodiment. As shown in element 902, the methods may include combining a liquid (e.g., an aqueous solution, such as water) with a chloride salt (e.g., MgCl₂). Citric acid, for example, may also be included with the liquid and chloride salt. As shown in element 904, the methods can include combining magnesium oxide, wollastonite, an additional material (e.g., lauric acid, stearic acid, and/or a metal stearate), and a filler (e.g., perlite). As shown in element 906, the methods can include the solution from element 902 with the components in element 904 to form a slurry. As shown in element 908, the methods can include providing (e.g., pouring) a mixture, such as a slurry, including liquid, chloride salt, magnesium oxide, wollastonite, an additional material (e.g., lauric acid, stearic acid, and/or a metal stearate), and a filler into a mold. As shown in element 910, the methods can include forming a solid material (e.g., a board) that includes a filler (e.g., vermiculite and/or perlite), a chloride salt, magnesium oxide, wollastonite, and a liquid (e.g., an aqueous solution, such as water). Forming the board or other solid material may include drying or curing the slurry at room temperature or any other temperature or conditions that allow the slurry to harden and form the board or other solid material. In at least one embodiment, curing conditions can include room temperature (e.g., about 65 F-70 F) and, e.g., a humidity level (e.g., about 80-90% relative humidity) for an initial time period, e.g., 12-24 hours. In some embodiments, curing conditions can include a temperature range between about 50-90 F and a humidity level about 50-95% relative humidity. In some embodiments, following an initial time period, panels can be removed e.g., from molds, and maintained at a temperature and humidity level (e.g., about 65-75 F and about 40-60% relative humidity) for a second time period (e.g., from about 7 to 28 days). In some embodiments, panels may be exposed during another time period at a different temperature and humidity levels (e.g. 50-90 F and 35-70% relative humidity). In at least one embodiment, a board or other solid material described further herein may be produced by the methods described further herein. The method shown in FIG. 9 can be used to make other solid materials or coating that have a desired shape. It will be appreciated by one of ordinary skill in the art that other components (e.g., a biopolymer) can be readily included, and the order of the steps is not limited to those described in FIG. 9. Furthermore, one of ordinary skill in the art will readily appreciate that the components (e.g., a filler, a biopolymer, an additional material) and the ranges (e.g., percent weight of the total weight of the slurries) described with respect to phosphate compositions and/or slurries can be used with methods of making chloride salt compositions, slurries, and/or solid materials (e.g., boards or other solid cementitious materials).

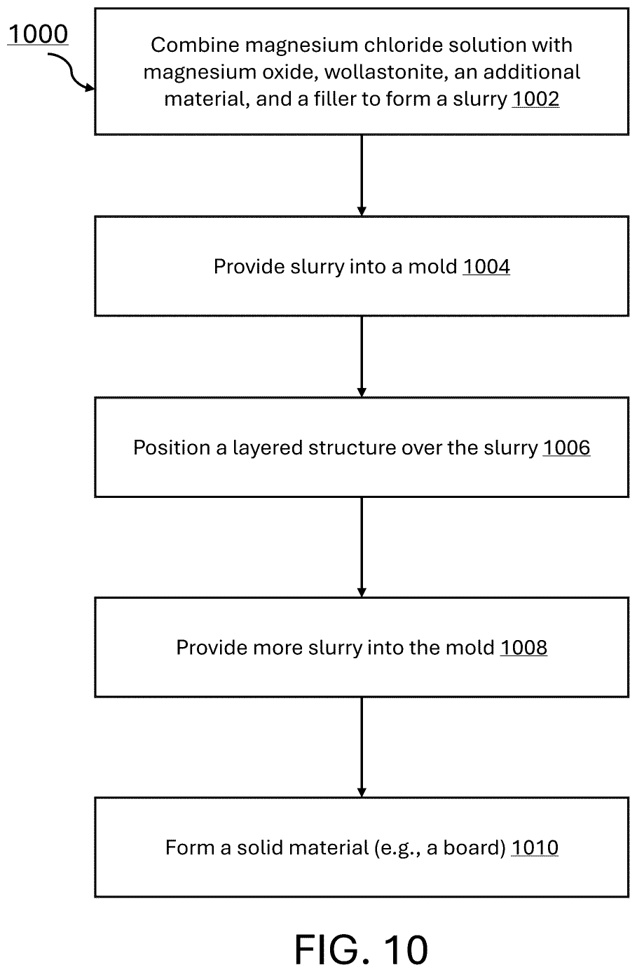

FIG. 10 shows a method 1000 of making a board, in accordance with at least one embodiment. As shown in element 1002, the methods can include combining a filler (e.g., vermiculite, pumice, a fiber (e.g., a fiberglass fiber, a basalt fiber, and/or a carbon fiber), perlite, or any combination thereof), a chloride salt, magnesium oxide, wollastonite, and a liquid (e.g., an aqueous solution, such as water) to form a slurry. As shown in element 1004, the methods can include providing (e.g., pouring) the slurry into a mold. As shown in element 1006, the methods can include positioning a layer, such as a mesh layer, over the slurry. As shown in element 808, the methods can include providing (e.g., pouring) more slurry into the mold. The methods may include one or more aspects of positioning a layered structure, such as a mesh layered structure, over the slurry and providing (e.g., pouring) more slurry into the mold. For example, steps 1006 and 1008 can be repeated one or more times before step 1010 to form the board. As shown in step 1010, the methods can include forming a board that includes a filler (e.g., vermiculite, pumice, a fiber (e.g., a fiberglass fiber, a basalt fiber, and/or a carbon fiber), perlite, or any combination thereof), a chloride salt, magnesium oxide, wollastonite, and a liquid (e.g., an aqueous solution, such as water). The method shown in FIG. 10 can be used to make other solid materials or coating that have a desired shape. It will be appreciated by one of ordinary skill in the art that other components (e.g., a fatty acid or other additional materials) can be readily included, and the order of the steps is not limited to those described in FIG. 10. Furthermore, one of ordinary skill in the art will readily appreciate that the components (e.g., a filler, a biopolymer, an additional material) and the ranges (e.g., percent weight of the total weight of the slurries) described with respect to phosphate compositions and/or slurries can be used with methods of making chloride salt compositions, slurries, and/or solid materials (e.g., boards or other solid cementitious materials). Forming the board or other solid material may include drying or curing the slurry at room temperature or any other temperature or conditions that allow the slurry to harden and form the board or other solid material. In at least one embodiment, curing conditions can include room temperature (e.g., about 65 F-70 F) and, e.g., a humidity level (e.g., about 80-90% relative humidity) for an initial time period, e.g., 12-24 hours. In some embodiments, curing conditions can include a temperature range between about 50-90 F and a humidity level about 50-95% relative humidity.

In some embodiments, following an initial time period, panels can be removed e.g., from molds, and maintained at a temperature and humidity level (e.g., about 65-75 F and about 40-60% relative humidity) for a second time period (e.g., from about 7 to 28 days). In some embodiments, panels may be exposed during another time period at a different temperature and humidity levels (e.g. 50-90 F and 35-70% relative humidity).

The following non-limiting examples are provided to further illustrate embodiments disclosed herein.

### EXAMPLES

### Example 1

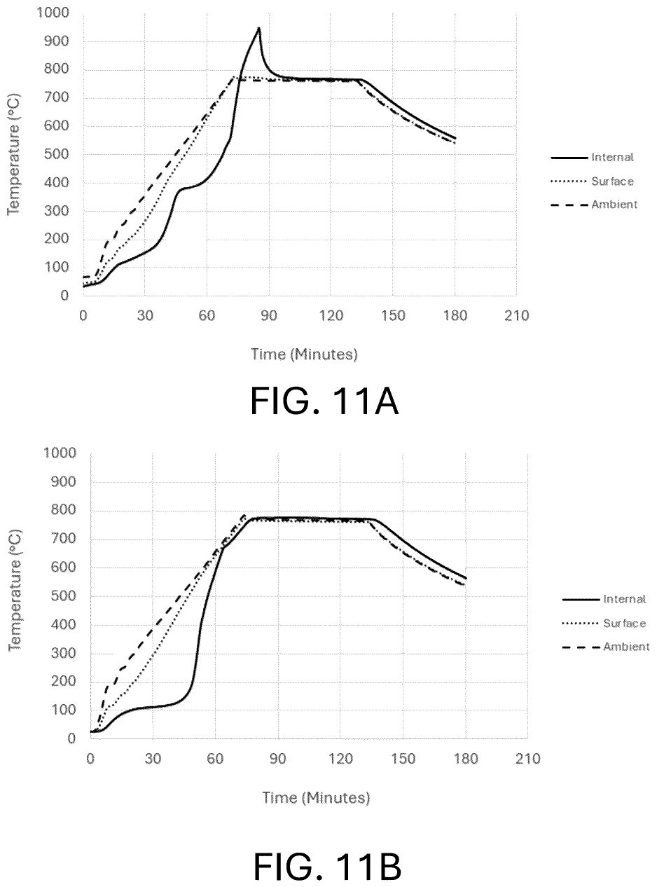

Assessment of combustibility can be performed through standard test methods. ASTM International (formally known as the American Society for Testing and Materials) has established a standard method for assessing combustibility of materials. The ASTM method is designated ASTM E136-24c, Standard Test Method for Assessing Combustibility of Materials Using a Vertical Tube Furnace at 750° C. FIGS. 11A and 6B illustrate temperature rise at 750° C. for a conventional, commercially available magnesium oxychloride panel including wood fiber (11A) and a panel described further herein (9B), which can include, e.g., light-burned MgO, wollastonite, MKP, casein, borax, citric acid, lauric acid, calcium stearate, vermiculite, and water. The data are derived from laboratory testing in accordance with ASTM E136-24c. Mass loss for both panel types was less than 50%. A conventional magnesium oxychloride, commercially available panel including wood fiber in FIG. 11A exhibits a temperature rise of over 190° C. from 750° C., which exceeds the maximum 30° C. rise allowed by ASTM E136-24c. The panel described herein in FIG. 11B exhibits a temperature rise of about 24° C. from 750° C., which meets the criteria for non-combustibility according to ASTM E136-24c.

### Example 2

Test panels were produced with the same proportions of binder materials, set retarders, vermiculite, and water (Table 1). Formulations of the example slurries varied only in the ratio of Wollastonite to MgO, and also included the same amounts of monopotassium phosphate, vermiculite and other admixture materials. Water content included a weight ratio of 1:2, water to total dry materials.

TABLE 1

| | Percent of Total Formulation (including water) | | | | | |
|---|---|---|---|---|---|---|
| Material | A | B | C | D | E | F |
| Light-Burned | 29.7 | 26.0 | 22.3 | 18.6 | 14.8 | 11.1 |
| MgO | | | | | | |
| Wollastonite | 0.0 | 3.7 | 7.4 | 11.1 | 14.8 | 18.6 |

By increasing Wollastonite concentrations, maximum hydration temperatures were reduced by up to 56.4% and set times were increased from 3 minutes to 100 minutes (Table 2). At the ratio of 30 grams (g):50 g (Wollastonite: MgO), maximum temperature was reduced by 22.8% and set times were increased from 3 minutes to 25 minutes.

TABLE 2

| | Max. Hydration | |
|---|---|---|
| Formulation (g) | Temperature | Set Time |
| (Wollastonite:MgO) | (° C.) | (Minutes) |
| A (0:80) | 66.3 | 3 |
| B (10:70) | 65.6 | 6 |
| C (20:60) | 62.6 | 12 |
| D (30:50) | 51.2 | 25 |
| E (40:40) | 39.3 | 45 |
| F (50:30) | 28.9 | 100 |

### Example 3

Assessments of water resistance can be performed using benchtop tests including ponding tests and hydrostatic pressure tests. Building codes recognize different methods for demonstrating water resistance. One example method involves water ponding in which one inch of water is held against the intended barrier for a minimum of 2 hours. Conditions of acceptance shall be that no water shall transmit through the membrane over the designated test period. Ponding can exceed the requirements established by ASTM E331-00(2023), Standard Test Method for Water Penetration of Exterior Windows, Skylights, Doors, and Curtain Walls by Uniform Static Air Pressure Difference. For example, ASTM E331-00(2023) employs a differential pressure of 2.86 pounds per square foot (psf) for a test duration of 15 minutes. Ponding can use a test pressure of 5.2 psf for a test duration of at least 2 hours.

Four panels (that are examples of the panels described further herein) having a thickness of 9 mm were produced containing a hydrophobic agent, lauric acid, at 1% of a total weight for all other components in the composition used in the slurry to make the panels. Water resistance was determined by 1-inch water column (5.2 psf) monitored at 1, 2, 5, and 24 hours.

Water resistance under low hydrostatic pressure was also assessed on panels (that are examples of the panels described further herein) produced with formulations including a combination of hydrophobic agents, including stearic acid, lauric acid, caprylic, oleic, and capric acid. Each of the four panels (9 mm thick) was subjected to a 5-inch water column for a period of 5 hours. As with ponding, hydrostatic pressure testing exceeds the requirements of ASTM E331-00 (2023), Standard Test Method for Water Penetration of Exterior Windows, Skylights, Doors, and Curtain Walls by Uniform Static Air Pressure Difference. For example, the five-inch water column equates to a test pressure of 26 pounds per square foot (psf), which is over 9 times greater than code-accepted requirements employed by ASTM E331-00(2023). The test duration of 5 hours is 20 times longer than the 15-minute exposure used by ASTM E331-00(2023).

The example results showed no evidence of liquid water transmission through the panels over the course of each test interval. The effects of hydrostatic pressure also showed no water penetration through the panels over a 5-hour test period.

### Example 4

The tables below show examples of components formed into solid material (e.g., boards) using methods described herein. Each component is shown in a weight of grams (g), and percent by weight of a component for the total weight of the combined components can be converted, e.g., by dividing 50 g of MgO by the total composition weight of 309 g. The examples were prepared using methods described herein, such as in FIGS. 5, 7, and 9 for phosphate, sulfate, and chloride materials, respectively. MgO in the examples below included light-burned MgO.

TABLE 3
Phosphates

| | Example | Example | Example | Example | Example | Example | Example |
|---|---|---|---|---|---|---|---|
| | A | B | C | D | E | F | G |
| | Weight | Weight | Weight | Weight | Weight | Weight | Weight |
| Component | (g) | (g) | (g) | (g) | (g) | (g) | (g) |
| MgO | 50 | 50 | 50 | 50 | 50 | 50 | 50 |
| Wollastonite | 40 | 40 | 40 | 40 | 40 | 40 | 40 |
| MKP | 90 | 90 | 90 | 90 | 90 | 90 | 90 |
| Citric Acid | 4 | 4 | 4 | 4 | 4 | 4 | 4 |
| Lauric Acid | 1 | 0 | 1 | 2 | 0 | 2 | 0 |
| Stearic Acid | 1 | 1 | 0 | 2 | 2 | 0 | 0 |
| Perlite | 13 | 13 | 13 | 13 | 13 | 13 | 13 |
| Ethanol (95%) | 10 | 10 | 10 | 10 | 10 | 10 | 10 |
| Water | 100 | 100 | 100 | 100 | 100 | 100 | 100 |

TABLE 5
Sulfates

| | Example | Example | Example | Example | Example | Example | Example |
|---|---|---|---|---|---|---|---|
| | A | B | C | D | E | F | G |
| | Weight | Weight | Weight | Weight | Weight | Weight | Weight |
| Component | (g) | (g) | (g) | (g) | (g) | (g) | (g) |
| MgO | 90 | 90 | 90 | 90 | 90 | 90 | 90 |
| Wollastonite | 30 | 30 | 30 | 30 | 30 | 30 | 30 |
| MgSO₄•7H₂O | 70 | 70 | 70 | 70 | 70 | 70 | 70 |
| Citric Acid | 1 | 1 | 1 | 1 | 1 | 1 | 1 |
| Lauric Acid | 1 | 0 | 1 | 2 | 0 | 2 | 0 |
| Stearic Acid | 1 | 1 | 0 | 2 | 2 | 0 | 0 |
| Perlite | 10 | 10 | 10 | 10 | 10 | 10 | 10 |
| Ethanol | 2 | 2 | 2 | 2 | 2 | 2 | 2 |
| (95%) | | | | | | | |
| Water | 100 | 100 | 100 | 100 | 100 | 100 | 100 |

TABLE 4
Chlorides

| | Example | Example | Example | Example | Example | Example | Example |
|---|---|---|---|---|---|---|---|
| | A | B | C | D | E | F | G |
| | Weight | Weight | Weight | Weight | Weight | Weight | Weight |
| Component | (g) | (g) | (g) | (g) | (g) | (g) | (g) |
| MgO | 80 | 80 | 80 | 80 | 80 | 80 | 80 |
| Wollastonite | 20 | 20 | 20 | 20 | 20 | 20 | 20 |
| MgCl₂•6H₂O | 70 | 70 | 70 | 70 | 70 | 70 | 70 |
| Citric Acid | 1 | 1 | 1 | 1 | 1 | 1 | 1 |
| Lauric Acid | 1 | 0 | 1 | 2 | 0 | 2 | 0 |
| Stearic Acid | 1 | 1 | 0 | 2 | 2 | 0 | 0 |
| Perlite | 15 | 15 | 15 | 15 | 15 | 15 | 15 |
| Ethanol (95%) | 2 | 2 | 2 | 2 | 2 | 2 | 2 |
| Water | 100 | 100 | 100 | 100 | 100 | 100 | 100 |

### Example 5

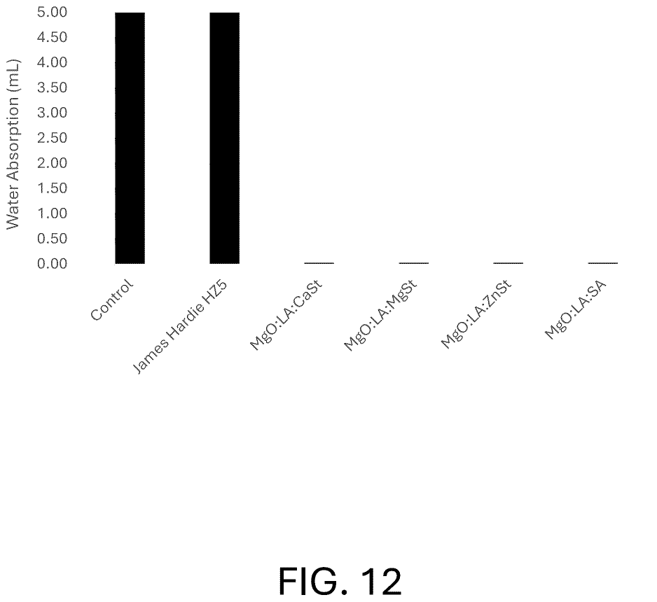

FIG. 12 depicts volumes of water absorption resulting from 24-hour hydrostatic pressure testing at 5 inches of water column using, e.g., a Rilem tube. Water repellency, for example, by solid material can be measured by an amount or rate of water uptake by the solid material when exposed to water ponding or hydrostatic pressure. A five-inch water column can apply a test hydrostatic pressure of 26 pounds per square foot (psf), which is over 9 times greater than code-accepted requirements employed by ASTM E331-00(2023), Standard Test Method for Water Penetration of Exterior Windows, Skylights, Doors, and Curtain Walls by Uniform Static Air Pressure Difference for testing water resistance. The test duration of 24 hours is 96 times longer than the 15-minute exposure used by ASTM E331-00(2023). As shown, a control panel represents a panel formed from a slurry that lacks hydrophobic or water repellant agents, and 5 mL of water was absorbed over the 24 hour testing. A fiber cement panel (James Hardie HZ5) represents a commercially available product that lacks factory primer on the tested back surface, and 5 mL of water was absorbed over the 24 hour testing.

Table 6 below shows example mixtures of compositions described further herein that when formed to a solid material (e.g., a board) surprisingly show improved water absorption characteristics. For example, combining lauric acid (LA) with at least one or a stearic acid (SA) or metal stearate (e.g., calcium stearate (CaSt), magnesium stearate (MgSt), and/or zinc stearate (ZnSt)) surprisingly exhibited less than 0.1 mL of water absorption from 24-hour hydrostatic pressure testing at 5 inches of water column as shown, for example, in FIG. 12. Table 6 shows example percent by weight (% by wt) for the total composition of the mixed components. The solid materials showed integral water repellency such that, for example, a board could be cut to expose an internal matrix that showed no discernable water absorption (less than about 0.1 mL) over 24 hours under 5 inches of water column using, e.g., a Rilem tube. The examples were prepared using methods described herein, such as in FIG. 5. MgO in the examples below included light-burned MgO.

TABLE 6

| | Control | LA:CaSt | LA:MgSt | LA:ZnSt | LA:SA |
|---|---|---|---|---|---|
| Component | (% by wt) | (% by wt) | (% by wt) | (% by wt) | (% by wt) |
| MgO | 16.3 | 16.1 | 16.1 | 16.1 | 16.1 |
| Wollastonite | 13.0 | 12.9 | 12.9 | 12.9 | 12.9 |
| MKP | 29.3 | 28.9 | 28.9 | 28.9 | 28.9 |
| Citric Acid | 1.3 | 1.3 | 1.3 | 1.3 | 1.3 |
| Lauric Acid | — | 0.6 | 0.6 | 0.6 | 0.6 |
| Ca Stearate | — | 0.6 | — | — | — |
| Mg Stearate | — | — | 0.6 | — | — |
| Zn Stearate | — | — | — | 0.6 | — |
| Stearic Acid | — | — | — | — | 0.6 |
| Perlite | 4.2 | 4.2 | 4.2 | 4.2 | 4.2 |
| Ethanol | 3.3 | 3.2 | 3.2 | 3.2 | 3.2 |
| (95%) | | | | | |
| Water | 32.6 | 32.2 | 32.2 | 32.2 | 32.2 |

### Example 6

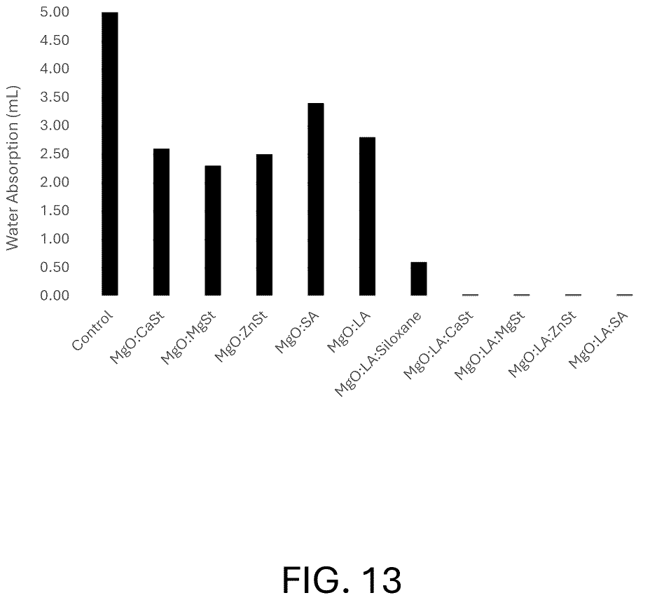

FIG. 13 depicts volumes of water absorption resulting from 24-hour hydrostatic pressure testing at 5 inches of water column using, e.g., a Rilem tube. Water repellency, for example, by solid material can be measured by an amount or rate of water uptake by the solid material when exposed to water ponding or hydrostatic pressure. A five-inch water column can apply a test hydrostatic pressure of 26 per square foot (psf), which is over 9 times greater than code-accepted requirements employed by ASTM E331-00(2023) for testing water resistance. The test duration of 24 hours is 96 times longer than the 15-minute exposure used by ASTM E331-00(2023).

Tables 7 and 8 below show other example phosphate mixtures of compositions described further herein that when formed to a solid material (e.g., a board) surprisingly show improved water absorption characteristics. For example, combining lauric acid with at least one of a stearic acid or metal stearate (e.g., calcium stearate, magnesium stearate, and/or zinc stearate) surprisingly exhibited less than 0.1 mL of water absorption as shown, for example, in FIG. 13. The data in Tables 7 and 8 associated with a control panel represents a panel formed from a slurry that does not include siloxane, lauric acid, stearic acid, and a metal stearate, and 5 mL of water was absorbed over the 24-hour testing. Tables 7 and 8 show additional example percent by weight (% by wt) for the total composition of the mixed components. The examples were prepared using methods described herein, such as in FIG. 5. MgO in the examples below included light-burned MgO.

TABLE 7

| | Control | CaSt | MgSt | ZnSt | SA | LA |
|---|---|---|---|---|---|---|
| Component | (% by wt) | (% by wt) | (% by wt) | (% by wt) | (% by wt) | (% by wt) |
| MgO | 16.3 | 16.1 | 16.1 | 16.2 | 16.2 | 16.2 |
| Wollastonite | 13.0 | 12.9 | 12.9 | 12.9 | 12.9 | 12.9 |
| MKP | 29.3 | 29.0 | 29.0 | 29.1 | 29.1 | 29.1 |
| Citric Acid | 1.3 | 1.3 | 1.3 | 1.3 | 1.3 | 1.3 |
| Lauric Acid | — | — | — | — | — | 0.6 |
| Ca Stearate | — | 1.1 | — | — | — | — |
| Mg Stearate | — | — | 1.0 | — | — | — |
| Zn Stearate | — | — | — | 0.6 | — | — |
| Stearic Acid | — | — | — | — | 0.8 | — |
| Siloxane | — | — | — | — | — | — |
| Perlite | 4.2 | 4.2 | 4.2 | 4.2 | 4.2 | 4.2 |
| Ethanol (95%) | 3.3 | 3.2 | 3.2 | 3.2 | 3.2 | 3.2 |
| Water | 32.6 | 32.2 | 32.3 | 32.4 | 32.3 | 32.4 |

TABLE 8

| | Control | LA:Siloxane | LA:CaSt | LA:MgSt | LA:ZnSt | LA:SA |
|---|---|---|---|---|---|---|
| Component | (% by wt) | (% by wt) | (% by wt) | (% by wt) | (% by wt) | (% by wt) |
| MgO | 16.3 | 15.9 | 16.1 | 16.1 | 16.1 | 16.1 |
| Wollastonite | 13.0 | 12.7 | 12.9 | 12.9 | 12.9 | 12.9 |
| MKP | 29.3 | 28.7 | 28.9 | 28.9 | 28.9 | 28.9 |
| Citric Acid | 1.3 | 1.3 | 1.3 | 1.3 | 1.3 | 1.3 |
| Lauric Acid | — | 0.6 | 0.6 | 0.6 | 0.6 | 0.6 |
| Ca Stearate | — | — | 0.6 | — | — | — |
| Mg Stearate | — | — | — | 0.6 | — | — |
| Zn Stearate | — | — | — | — | 0.6 | — |
| Stearic Acid | — | — | — | — | — | 0.6 |
| Siloxane | — | 1.6 | — | — | — | — |
| Perlite | 4.2 | 4.1 | 4.2 | 4.2 | 4.2 | 4.2 |
| Ethanol (95%) | 3.3 | 3.2 | 3.2 | 3.2 | 3.2 | 3.2 |
| Water | 32.6 | 31.8 | 32.2 | 32.2 | 32.2 | 32.2 |

### Example 7

Tables 9-14 shows additional examples of starting materials that were formed into solid boards using methods described herein, such as in FIG. 5. MgO in the examples below included light-burned MgO.

TABLE 9

| | Example | Example | Example | Example | Example | Example |
|---|---|---|---|---|---|---|
| | A | B | C | D | E | F |
| | Weight | Weight | Weight | Weight | Weight | Weight |
| Component | (g) | (g) | (g) | (g) | (g) | (g) |
| MgO | 50 | 50 | 60 | 70 | 50 | 50 |
| Wollastonite | 40 | 40 | 30 | 20 | 40 | 40 |
| MKP | 90 | 90 | 90 | 90 | 80 | 100 |
| Citric Acid | 4 | 4 | 4 | 4 | 4 | 4 |
| Lauric Acid | 1 | 2 | 1.5 | 1.5 | 1.5 | 1.5 |
| Stearic Acid | 1 | 2 | 1.5 | 1.5 | 1.5 | 1.5 |
| Perlite | 13 | 13 | 13 | 13 | 13 | 13 |
| Ethanol (95%) | 10 | 10 | 10 | 10 | 10 | 10 |
| Water | 100 | 100 | 100 | 100 | 100 | 100 |

TABLE 10

| | Example | Example | Example | Example | Example | Example |
|---|---|---|---|---|---|---|
| | G | H | I | J | K | L |
| | Weight | Weight | Weight | Weight | Weight | Weight |
| Component | (g) | (g) | (g) | (g) | (g) | (g) |
| MgO | 50 | 50 | 50 | 60 | 60 | 60 |
| Wollastonite | 40 | 30 | 30 | 40 | 30 | 30 |
| MKP | 90 | 70 | 70 | 90 | 90 | 100 |
| Citric Acid | 4 | 4 | 4 | 5 | 5 | 5 |
| Lauric Acid | 0.5 | 4 | 5 | 2 | 1 | 1.5 |
| Stearic Acid | 0.5 | 4 | 5 | 2 | 1 | 1.5 |
| Perlite | 13 | 5 | 5 | 13 | 13 | 13 |
| Ethanol (95%) | 10 | 10 | 10 | 5 | 5 | 5 |
| Water | 100 | 80 | 80 | 100 | 100 | 100 |

TABLE 11

| | Example | Example | Example | Example | Example | Example |
|---|---|---|---|---|---|---|
| | M | N | O | P | Q | R |
| | Weight | Weight | Weight | Weight | Weight | Weight |
| Component | (g) | (g) | (g) | (g) | (g) | (g) |
| MgO | 50 | 50 | 50 | 50 | 50 | 50 |
| Wollastonite | 40 | 40 | 40 | 40 | 40 | 40 |
| MKP | 90 | 90 | 90 | 90 | 90 | 90 |
| Citric Acid | 4 | 4 | 5 | 5 | 3 | 3 |
| Lauric Acid | 1 | 1 | 1 | 2 | 1 | 1 |
| Stearic Acid | 1 | 1 | 1 | 2 | 1 | 1 |
| Perlite | 18 | 22 | 13 | 13 | 0 | 0 |
| Ethanol (95%) | 10 | 10 | 0 | 0 | 10 | 15 |
| Water | 100 | 100 | 100 | 100 | 70 | 70 |

TABLE 12

| | Example S | Example T |
|---|---|---|
| Component | Weight (g) | Weight (g) |
| MgO | 50 | 50 |
| Wollastonite | 40 | 40 |
| MKP | 90 | 90 |
| Citric Acid | 4 | 4 |
| Lauric Acid | 1 | 1 |
| Calcium Stearate | 2 | 3 |
| Perlite | 13 | 13 |
| Ethanol (95%) | 10 | 10 |
| Water | 100 | 100 |

TABLE 13

| | Example U | Example V |
|---|---|---|
| Component | Weight (g) | Weight (g) |
| MgO | 50 | 50 |
| Wollastonite | 40 | 40 |
| MKP | 90 | 90 |
| Citric Acid | 4 | 4 |
| Lauric Acid | 1 | 1 |
| Magnesium Stearate | 2 | 3 |
| Perlite | 13 | 13 |
| Ethanol (95%) | 10 | 10 |
| Water | 100 | 100 |

TABLE 14

| | Example W | Example X |
|---|---|---|
| Component | Weight (g) | Weight (g) |
| MgO | 50 | 50 |
| Wollastonite | 40 | 40 |
| MKP | 90 | 90 |
| Citric Acid | 4 | 4 |
| Lauric Acid | 1 | 1 |
| Zinc Stearate | 2 | 3 |
| Perlite | 13 | 13 |
| Ethanol (95%) | 10 | 10 |
| Water | 100 | 100 |

### Example 8

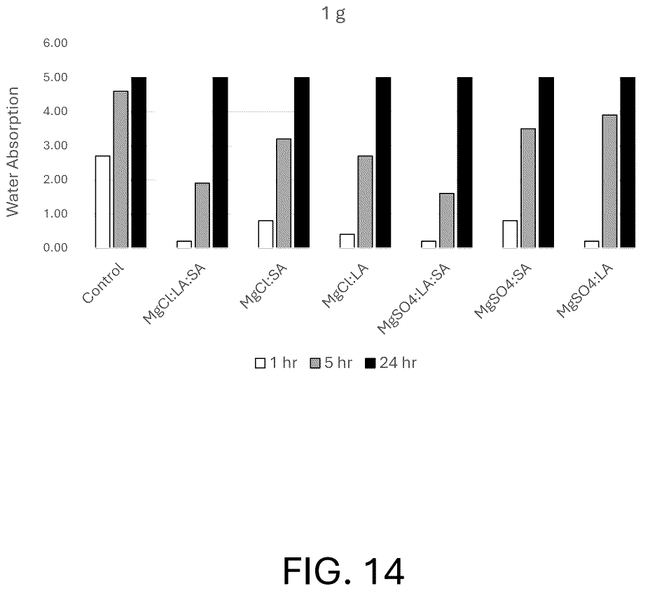

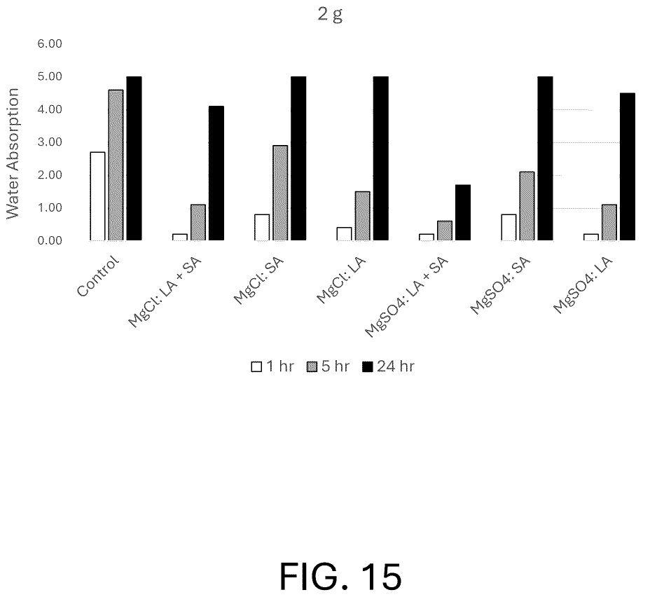

FIGS. 14 and 15 depict volumes of water absorption resulting from 24-hour hydrostatic pressure testing at 5 inches of water column using, e.g., a Rilem tube for solid materials including magnesium chloride and magnesium sulfate. Water repellency, for example, by solid material can be measured by an amount or rate of water uptake by the solid material when exposed to water ponding or hydrostatic pressure. A five-inch water column can apply a test hydrostatic pressure of 26 per square foot (psf), which is over 9 times greater than code-accepted requirements employed by ASTM E331-00(2023) for testing water resistance. The test duration of 24 hours is 96 times longer than the 15-minute exposure used by ASTM E331-00(2023).

Tables 15-18 below show other example magnesium chloride and magnesium sulfate mixtures of compositions described further herein that when formed to a solid material (e.g., a board) surprisingly show improved water absorption characteristics. For example, combining lauric acid with stearic acid surprisingly exhibited lower water absorption as compared to a control solid material that did not include lauric acid and stearic acid, for example, in FIG. 14. The examples were prepared using methods described herein, such as in FIGS. 7 and 9 for magnesium sulfate and magnesium chloride, respectively. MgO in the examples below included light-burned MgO.

TABLE 15

| | Control | LA + SA | SA | LA |
|---|---|---|---|---|
| | Weight | Weight | Weight | Weight |
| Component | (g) | (g) | (g) | (g) |
| MgO | 80 | 80 | 80 | 80 |
| Wollastonite | 20 | 20 | 20 | 20 |
| MgCl₂•6H₂O | 70 | 70 | 70 | 70 |
| Citric Acid | 1 | 1 | 1 | 1 |
| Lauric Acid | 0 | 1 | 0 | 1 |
| Stearic Acid | 0 | 1 | 1 | 0 |
| Perlite | 15 | 15 | 15 | 15 |
| Ethanol (95%) | 2 | 2 | 2 | 2 |
| Water | 100 | 100 | 100 | 100 |

TABLE 16

| | Control | LA + SA | SA | LA |
|---|---|---|---|---|
| | Weight | Weight | Weight | Weight |
| Component | (g) | (g) | (g) | (g) |
| MgO | 80 | 80 | 80 | 80 |
| Wollastonite | 20 | 20 | 20 | 20 |
| MgCl₂•6H₂O | 70 | 70 | 70 | 70 |
| Citric Acid | 1 | 1 | 1 | 1 |
| Lauric Acid | 0 | 2 | 0 | 2 |
| Stearic Acid | 0 | 2 | 2 | 0 |
| Perlite | 15 | 15 | 15 | 15 |
| Ethanol (95%) | 2 | 2 | 2 | 2 |
| Water | 100 | 100 | 100 | 100 |

TABLE 17

| | Control | LA + SA | SA | LA |
|---|---|---|---|---|
| | Weight | Weight | Weight | Weight |
| Component | (g) | (g) | (g) | (g) |
| MgO | 90 | 90 | 90 | 90 |
| Wollastonite | 30 | 30 | 30 | 30 |
| MgSO₄•7H₂O | 70 | 70 | 70 | 70 |
| Citric Acid | 0 | 1 | 1 | 1 |
| Lauric Acid | 0 | 1 | 0 | 1 |
| Stearic Acid | 1 | 1 | 1 | 0 |
| Perlite | 10 | 10 | 10 | 10 |
| Ethanol (95%) | 2 | 2 | 2 | 2 |
| Water | 100 | 100 | 100 | 100 |

TABLE 18

| | Control | LA + SA | SA | LA |
|---|---|---|---|---|
| | Weight | Weight | Weight | Weight |
| Component | (g) | (g) | (g) | (g) |
| MgO | 90 | 90 | 90 | 90 |
| Wollastonite | 30 | 30 | 30 | 30 |
| MgSO₄•7H₂O | 70 | 70 | 70 | 70 |
| Citric Acid | 0 | 1 | 1 | 1 |
| Lauric Acid | 0 | 2 | 0 | 2 |
| Stearic Acid | 1 | 2 | 2 | 0 |
| Perlite | 10 | 10 | 10 | 10 |
| Ethanol (95%) | 2 | 2 | 2 | 2 |
| Water | 100 | 100 | 100 | 100 |

### Example 9

Materials that form surface droplets in humid conditions (e.g., deliquescence) can increase corrosion risks with contacting metals such as fasteners, cladding attachment systems, and steel framing. A board, which included wollastonite, formed according to Example A in Table 19 surprisingly showed no evidence of deliquescence (e.g., surface droplets of water) when exposed to 35° C. and 90% relative humidity for a period of 72 hours. Further exposure for a total of 96 hours also revealed no evidence of deliquescence. The same board was also exposed to an additional 72 hours at 35° C. and 95% relative humidity without signs of deliquescence or dehalogenation. A board represented in Example B, which included wollastonite, similarly did not show evidence of deliquescence (e.g., surface droplets) after more than 52 hours in 35° C. and 90% relative humidity. In contrast, the board, which did not include wollastonite, represented in Example C showed surface water droplets that formed due to deliquescence within about one hour at 35° C. and 90% relative humidity. The examples were prepared using methods described herein, such as in FIG. 9. MgO in the examples below included light-burned MgO.

TABLE 19

| | Example A | Example B | Example C |
|---|---|---|---|
| Component | Weight (g) | Weight (g) | Weight (g) |
| MgO | 80 | 80 | 80 |
| Wollastonite | 20 | 30 | 0 |
| MgCl₂•6H₂O | 70 | 90 | 90 |
| Citric Acid | 1 | 1 | 1 |
| Lauric Acid | 1 | — | — |
| Stearic Acid | 1 | — | — |
| Perlite | 15 | 15 | 15 |
| Water | 100 | 100 | 100 |

Free chloride concentrations were determined for Examples B and C in Table 19 using a method of silver nitrate titration. The method measures free chloride ion content of magnesium oxide boards by leaching of free chloride in a board into boiling distilled water and followed by cooling for one hour. Once leached, the chloride is titrated for determining the level of free chloride. An example method can includes crushing 1″×1″ specimen and weighing out 2.0000+/−0.005 grams of crushed specimen. A Silver Nitrate Solution, 0.1 N (AgNO3), stored in a dark bottle and out of light can be used. Potassium Chromate Indicator solution (10% w/v)—10 g dissolved in 100 ml of deionized water can be used. The method can include combining approximately 50 ml of boiling distilled water with the crushed specimen and soaking for one hour. After one hour, the specimen can be filtered using filter paper and decanting the water off into a clean beaker. The crushed specimen can be rinsed two times with deionized water. 4-5 drops of the 10% w/v potassium chromate indicator solution can be added. A stir bar can be placed into the beaker on a magnetic stirrer. A burette can be filled with the 0.1 N (17 g/l) silver nitrate solution and adjusted to 0.0 ml. While stirring the specimen, the specimen can be slowly titrated with silver nitrate solution while watching the color. The first color observed includes yellow solution becoming cloudy with a white precipitate. As the soluble chloride is consumed, the silver nitrate can react with the potassium chromate to turn the beaker contents orange. When the orange color is persistent (present for over 10-15 seconds) the titration is complete. Record the volume of 0.1000N silver nitrate for each specimen by reading the burette to the nearest 0.1 ml. The % free chloride (% FC) is calculated as follows: % FC equals (((t)(0.001)(3.545))/m)×100, where % FC is measured free leachable chloride content, expressed as a percentage (%), t is measured volume of silver nitrate required for titration, in milliliters (ml), and m is measured mass of specimen, in grams (g).

Example B, which included wollastonite, in Table 19 included 4.06% of free chloride and showed no deliquescence (e.g., surface water droplets) after 52 hours at 35 degrees F. and 90% relative humidity. Example C, which did not include any wollastonite, included 4.77% of free chloride and showed deliquescence within one hour at 35 degrees F. and 90% relative humidity. There was about a 14.9% difference in free chloride between Example B and C.

### Example 10

Examples A-F in Table 20 were prepared using methods described herein, such as in FIG. 7. As shown in the corresponding Table 21, wollastonite improves dimensional stability (e.g., board warp) and flexural strength of the boards described herein as compared to examples that lack wollastonite. Test panels having the dimensions of 12 in×12 in were formed with the following formulations.

TABLE 20

| | Weight | Weight | Weight | Weight | Weight | Weight |
|---|---|---|---|---|---|---|
| | (g) | (g) | (g) | (g) | (g) | (g) |
| Component | A | B | C | D | E | F |
| MgO | 567 | 567 | 567 | 693 | 693 | 693 |
| Wollastonite | 189 | 189 | 189 | 63 | 63 | 63 |
| MgSO₄•7H₂O | 441 | 441 | 441 | 441 | 441 | 441 |
| Citric Acid | 6.3 | 6.3 | 6.3 | 6.3 | 6.3 | 6.3 |
| Perlite | 63 | 63 | 63 | 63 | 63 | 63 |
| Water | 630 | 630 | 630 | 630 | 630 | 630 |

Boards were cured from slurries including the components listed in Table 20 at 70 degrees F. and 80-90% relative humidity for 24 hours and then further cured at 70 degrees F. and 40-50% relative humidity for an additional 120 hours (5 days). Warp was determined by applying a calibrated straight edge along the convex face and recording the maximum deviation between the panel and straight edge. Flexural strength was determined with a universal testing machine in accordance with ASTM C1185-08 (2016). Specimen dimensions were as follows: 6 in (width)×12 in (length)×0.5 in. Slurries used to form examples A-C included 10% wt of wollastonite and showed 0 mm/1 ft of warp. Slurries used to form examples D-F included 3.3% wt of wollastonite and showed between 3-3.5 mm/1 ft of warp.

TABLE 21

| | Wollastonite (10% wt) | | | Wollastonite (3.3% wt) | | |
|---|---|---|---|---|---|---|
| | A | B | C | D | E | F |
| Warp | 0 | 0 | 0 | 3 mm | 3.5 mm | 3.5 mm |
| Flexural | 20.9 | 20.7 | 21.6 | 13.9 | 12.7 | 13.4 |
| Strength | | | | | | |
| (MPa) | | | | | | |

At least one embodiment of the disclosure can be described in view of the following clauses:

Clause 1. A solid material, comprising:
a magnesium oxide;
wollastonite;
at least one of a phosphate salt, a sulfate salt, and a chloride salt.

Clause 2. The solid material of clause 1, wherein the wollastonite comprises at least about 5% weight of wollastonite, at least about 10% weight of wollastonite, at least about 15% weight of wollastonite, at least about 20% weight of wollastonite, or at least about weight of 25% wollastonite of a total weight of a slurry formed into the solid material.

Clause 3. The solid material of any of clauses 1-2, wherein the wollastonite comprises between about 5 to 30% weight of a total weight of a slurry that is formed into the solid material, between about 5 to 20% weight of a total weight of a slurry that is formed into the solid material, or between about 5 to 15% weight of a total weight of a slurry that is formed into the solid material.

Clause 4. The solid material of any of clauses 1-3, wherein the magnesium oxide comprises light-burned magnesium oxide, hard-burned magnesium oxide, dead-burned magnesium oxide, or any combination thereof.

Clause 5. The solid material of any of clauses 1-4, wherein a ratio of wollastonite:MgO is between about 0.6 to about 1.2 by weight, a ratio of wollastonite to magnesium oxide can be between about 0.3 and 1.2 by weight, a ratio of wollastonite to magnesium oxide may be between about 0.5 and 1.2 by weight, a ratio of wollastonite to magnesium oxide may between about 0.6 to 1.1 by weight, a ratio of wollastonite to magnesium oxide can between about 0.6 to 1.0 by weight, a ratio of wollastonite to magnesium oxide can between about 0.6 to 0.9 by weight, a ratio of wollastonite to magnesium oxide can between about 0.6 to 0.8 by weight, or a ratio of wollastonite to magnesium oxide may between about 0.6 to 0.7 by weight.

Clause 6. The solid material of any of clauses 1-5, wherein the magnesium oxide comprises light-burned magnesium oxide, and the solid material comprises a weight ratio of magnesium oxide to phosphate salt that comprises less than or equal to about 1.0, comprises less than about 0.9, comprises less than about 0.8, comprises less than about 0.7, comprises less than about 0.6, is between about 0.4 and 1.0, is between about 0.5 and 1.0, is between about 0.6 and 1.0, is between about 0.6 and 0.9, is between about 0.6 and 0.8, or is between about 0.6 and 0.75.

Clause 7. The solid material of any of clauses 1-6, wherein the magnesium oxide comprises at least one of hard-burned magnesium oxide and dead-burned magnesium oxide, and the solid material comprises a weight ratio of magnesium oxide to phosphate salt that comprises that is greater than about 1.0, is greater than about 1.2, is greater than about 1.4, is greater than about 1.6, is greater than about 1.8, is greater than about 2, is greater than about 2.2, is between about 1 and 2.2, is between about 1.5 and 2.2, is between about 1.8 and 2.2, or is between about 1.9 and 2.1.

Clause 8. The solid material of any of clauses 1-7, further comprising a fatty acid.

Clause 9. The solid material of any of clauses 1-8, further comprising a metal stearate.

Clause 10. The solid material of any of clauses 1-9, further comprising lauric acid, stearic acid, a metal stearate, or any combination thereof.

Clause 11. The solid material of any of clauses 1-10, wherein the lauric acid comprises between 0.2-2.0 percent of a total weight of a slurry formed into the solid cementitious material.

Clause 12. The solid material of any of clauses 1-11, wherein the stearic acid comprises between 0.2-2.0 percent of a total weight of a slurry formed into the solid cementitious material.

Clause 13. The solid material of any of clauses 1-12, wherein the metal stearate comprises calcium stearate, magnesium stearate, zinc stearate, or any combination thereof.

Clause 14. The solid material of any of clauses 1-13, wherein the metal stearate comprises calcium stearate, magnesium stearate, or zinc stearate ranging between about 0.2-2.0 percent of a total weight of a slurry formed into the solid cementitious material.

Clause 15. The solid material of any of clauses 1-14, further comprising a filler.

Clause 16. The solid material of any of clauses 1-15, further comprising vermiculite, perlite, pumice, a fiber, or a combination thereof.

Clause 17. The solid material of any of clauses 1-16, comprising the phosphate salt, and the solid material further comprising a filler ranging from about 3% to about 10%, from about 4% to about 10%, from about 5% to about 8%, from about 8% to about 10%, from about 3% to about 5%, or from about 4% to about 6% of a total weight of a slurry formed into the solid material.

Clause 18. The solid material of any of clauses 1-17, comprising the sulfate salt, and the solid material further comprising a filler ranging from about 0.1% to about 9% of a total weight of the slurry, from about 2% to about 7%, and from about 2% to about 4% of a total weight of a slurry formed into the solid material.

Clause 19. The solid material of any of clauses 1-18, comprising the chloride salt, and the solid material further comprising a filler ranging from about 0.1% to about 9% of a total weight of the slurry, from about 1% to about 7%, and from about 3% to about 7% of a total weight of a slurry formed into the solid material.

Clause 20. The solid material of any of clauses 1-19, further comprising a retarder.

Clause 21. The solid material of any of clauses 1-20, further comprising citric acid.

Clause 22. The solid material of any of clauses 1-21, further comprising a retarder ranging from about 0.2% to about 2%, from about 0.2% to about 1.5%, from about 0.6% to about 1.1%, from about 0.7% to about 1.4%, from about 0.5% to about 1.5%, or from about 0.2% to about 1% of a total weight of a slurry formed into the solid material.

Clause 23. The solid material of any of clauses 1-22, further comprising a hydrophobic agent, a fatty acid, a wax emulsion, a metal stearate, a densifier, a crystalline admixture, or any combinations thereof.

Clause 24. The solid material of any of clauses 1-23, comprising the phosphate salt, wherein the wollastonite comprises between about 5 to 30% weight of a total weight of a slurry that is formed into the solid material, between about 5 to 20% weight of a total weight of a slurry that is formed into the solid material, between about 5 to 15% weight of a total weight of a slurry that is formed into the solid material, 4% to about 18% of a total weight of the slurry that is formed into the solid material, from about 6% to about 16% of a total weight of the slurry that is formed into the solid material, from about 8% to about 12% of a total weight of the slurry that is formed into the solid material, from about 10% to about 16% of a total weight of the slurry that is formed into the solid material, from about 4% to about 10% of a total weight of the slurry that is formed into the solid material, greater than about 5% of a total weight of the slurry that is formed into the solid material, or greater than about 10% of a total weight of the slurry that is formed into the solid material.

Clause 25. The solid material of any of clauses 1-24, wherein the phosphate salt comprises monopotassium phosphate.

Clause 26. The solid material of any of clauses 1-25, wherein the phosphate salt comprises crystals having dimensions of less than about 0.5 mm, 0.4 mm, 0.3 mm, 0.2 mm, or less than 0.1 mm, or less than 0.05 mm.

Clause 27. The solid material of any of clauses 1-26, wherein the phosphate salt comprises crystals between about 0.05 mm and 0.1 mm, between about 0.5 mm and 0.05 mm, between about 0.4 mm and 0.05 mm, between about 0.3 mm and 0.05 mm, between about 0.2 mm and 0.05 mm, or between about 0.1 mm and 0.05 mm.

Clause 28. The solid material of any of clauses 1-27, comprising the sulfate salt, wherein the wollastonite comprises between about 5% to about 30% of a total weight of a slurry that is formed into the solid material, between about 5% to about 20% of a total weight of a slurry that is formed into the solid material, between about 7% to about 15% of a total weight of a slurry that is formed into the solid material, greater than about 5% of a total weight of the slurry that is formed into the solid material, greater than about 10% of a total weight of the slurry that is formed into the solid material, greater than about 15% of a total weight of the slurry that is formed into the solid material, greater than about 20% of a total weight of the slurry that is formed into the solid material, or greater than about 25% of a total weight of the slurry that is formed into the solid material.

Clause 29. The solid material of any of clauses 1-28, wherein the sulfate salt comprises magnesium sulfate.

Clause 30. The solid material of any of clauses 1-29, wherein the sulfate salt comprises magnesium sulfate heptahydrate (MgSO₄·7H₂O).

Clause 31. The solid material of any of clauses 1-30, comprising the chloride salt, wherein the wollastonite comprises between about 5% to about 30% of a total weight of a slurry that is formed into the solid material, between about 5% to about 20% of a total weight of a slurry that is formed into the solid material, between about 5% to about 10% of a total weight of the slurry that is formed into the solid material, greater than about 5% of a total weight of the slurry that is formed into the solid material, greater than about 10% of a total weight of the slurry that is formed into the solid material, greater than about 15% of a total weight of the slurry that is formed into the solid material, greater than about 20% of a total weight of the slurry that is formed into the solid material, or greater than about 25% of a total weight of the slurry that is formed into the solid material.

Clause 32. The solid material of any of clauses 1-31, wherein the chloride salt comprises magnesium chloride.

Clause 33. The solid material of any of clauses 1-32, wherein the chloride salt comprises magnesium chloride hexahydrate (MgCl₂·6H₂O).

Clause 34. The solid material of any of clauses 1-33, comprising the phosphate salt, wherein the solid material absorbs less than 0.1 mL of water over 24 hours when exposed to a five-inch water column test.

Clause 35. The solid material of any of clauses 1-34, comprising the sulfate salt, wherein the solid material absorbs less than 1 mL of water over 1 hour when exposed to a five-inch water column test.

Clause 36. The solid material of any of clauses 1-35, comprising the chloride salt, wherein the solid material absorbs less than 1 mL of water over 1 hour when exposed to a five-inch water column test.

Clause 37. The solid material of any of clauses 1-36, comprising the chloride salt, wherein the solid material exhibits no deliquescence when exposed to 35° C. and 90% relative humidity for a period of 72 hours.

Clause 38. The solid material of any of clauses 1-37, further comprising a liquid.

Clause 39. The solid material of any of clauses 1-38, further comprising a liquid between about 20% to about 40%, about 30% to about 40%, between about 30% to about 35%, between about 35% to about 40%, between about 32% to about 36%, between about 30% to about 36%, or between about 34% to about 38% of a total weight of a slurry formed into the solid material.

Clause 40. The solid material of any of clauses 1-39, further comprising water.

Clause 41. The solid material of any of clauses 1-40, further comprising ethanol.

Clause 42. The solid material of any of clauses 1-41, further comprising ethanol ranging between 0.5 to 3% weight of a total weight of a slurry formed into the solid material.

Clause 43. The solid material of any of clauses 1-42, further comprising a biopolymer.

Clause 44. The solid material of any of clauses 1-43, further comprising casein.

Clause 45. The solid material of any of clauses 1-44, further comprising a biopolymer ranging from about 0.1% to about 1.2%, from about 0.2% to about 1%, from about 0.2% to about 0.8%, from about 0.2% to about 0.5%, and from about 0.5% to about 1% of a total weight of a slurry formed into the solid material.

Clause 46. The solid material of any of clauses 1-45, further comprising a combination of two or more biopolymers ranging from about 0.2% to about 2.4%, from about 0.4% to about 2%, from about 0.4% to about 1.6%, from about 0.4% to about 1%, and from about 1% to about 2% of a total weight of a slurry formed into the solid material.

Clause 47. The solid material of any of clauses 1-46, comprising a solid cementitious material.

Clause 48. The solid material of any of clauses 1-47, comprising a board.

Clause 49. The solid material of any of clauses 1-48, comprising a flexural strength of greater than about 10 MPa, greater than about 15 MPa, greater than about 20 MPa, greater than about 25 MPa, between about 10 MPa to about 15 MPa, between about 10 MPa to about 25 MPa, between about 15 MPa to about 20 MPa.

Clause 50. The solid material of any of clauses 1-49, comprising a warping of about 0 mm of over at least 1 foot of a dimension of the solid material, a warping of about 1 mm of over at least 1 foot of a dimension of a dimension of the solid material, or a warping of about 2 mm over at least 1 foot of a dimension of the solid material.

Clause 51. The solid material of any of clauses 1-50, comprising a board comprising a protrusion.

Clause 52. The solid material of any of clauses 1-51, comprising a board comprising a protrusion that recesses towards a middle of the board away from a surface of the board, a protrusion that extends outward from the surface of the board, or a combination thereof.

Clause 53. The solid material of any of clauses 1-52, comprising a board coupled to an assembly comprising a water resistive barrier, a sheathing, a wall framing, or any combination thereof.

Clause 54. A method of making the solid material of any of clauses 1-53.

Clause 55. A method of making the solid material of any of clauses 1-54, comprising: combining magnesium oxide, wollastonite, at least one of the phosphate salt, the sulfate salt, and the chloride salt, and a liquid to form a slurry; and forming the solid material from the slurry.

Clause 56. A method of making the solid material of any of clauses 1-55, the solid material comprising the phosphate salt, wherein the method comprises:
combining magnesium oxide, wollastonite, and a liquid;
combining the phosphate salt with the magnesium oxide, the wollastonite, and the liquid;
providing a quantity of a slurry comprising magnesium oxide, the wollastonite, the liquid, and the phosphate salt into a mold; and
forming the solid material.

Clause 57. The method of making the solid material of any of clauses 1-56, the solid material comprising at least one of the sulfate salt and the chloride salt, wherein the method comprises:
combining the at least one of the sulfate salt and the chloride salt with the magnesium oxide, the wollastonite, and a liquid;
providing a quantity of a slurry comprising magnesium oxide, the wollastonite, the liquid, and the at least one of the sulfate salt and the chloride salt into a mold; and
forming the solid material.

Clause 58. The method of making the solid material of any of clauses 1-57, comprising curing the slurry into the solid material for a first time period at a first temperature and a first humidity level.

Clause 59. The method of making the solid material of any of clauses 1-58, wherein the first time period comprises about 12 hours to about 24 hours.

Clause 60. The method of making the solid material of any of clauses 1-59, wherein the first temperature comprises about 50 degrees F. to about 90 degrees F. or about 65 degrees F. to about 75 degrees F.

Clause 61. The method of making the solid material of any of clauses 1-60, wherein the first humidity level comprises about 50% to about 95% relative humidity or about 80% to about 90% relative humidity.

Clause 62. The method of making the solid material of any of clauses 1-61, comprising curing the slurry into the solid material for a second time period after the first time period at a second temperature and a second humidity level.

Clause 63. The method of making the solid material of any of clauses 1-62, wherein the second time period comprises about 7 days to about 28 days.

Clause 64. The method of making the solid material of any of clauses 1-63, wherein the second temperature comprises about 65 degrees F. to about 75 degrees F.

Clause 65. The method of making the solid material of any of clauses 1-64, wherein the second humidity level comprises about 40% to about 65% relative humidity.

Clause 66. A method of making the solid material of any of clauses 1-65, comprising:
combining magnesium oxide, wollastonite, and a liquid;
combining the phosphate salt with the magnesium oxide, the wollastonite, and the liquid;
providing a first quantity of a slurry comprising magnesium oxide, the wollastonite, the liquid, and the phosphate salt into a mold; and
forming the solid material.

Clause 66. The method of making the solid material of any of clauses 1-65, further comprising positioning a first mesh layer over at least a portion of the first quantity of the slurry.

Clause 67. The method of making the solid material of any of clauses 1-66, further comprising providing a second quantity of the slurry comprising the magnesium oxide, wollastonite, the liquid, and the phosphate salt into the mold.

Clause 68. The method of making the solid material of any of clauses 1-67, further comprising positioning a second mesh layer over at least a portion of the second quantity of the slurry.

Clause 69. The method of making the solid material of any of clauses 1-68, wherein the first quantity of the slurry comprises one slurry.

Clause 70. The method of making the solid material of any of clauses 1-69, further comprising combining the filler, the fatty acid, the lauric acid, the stearic acid, the metal stearate, the retarder, the biopolymer, the ethanol, the citric acid, or any combination thereof with the magnesium oxide, wollastonite, the phosphate salt, the sulfate salt, the chloride salt, or any combination thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

In some embodiments, the numbers expressing quantities of ingredients, properties such as molecular weight, weights, lengths, ratios, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Use of “and/or” is to be construed to cover either one of each item identified individually or a combination of both. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal. An amount of a component described herein (e.g., MgO in a slurry) can be represented, for example, as a weight percent or a range of percent weights of total weight of a slurry that includes other components (e.g., wollastonite, a salt, and a liquid). An amount of a component described herein can be represented as a weight (e.g., MgO in grams (g)). An amount of a component (e.g., MgO) can be represented as a weight ratio as compared to another component (e.g., a phosphate salt). One of ordinary skill in the art will appreciate that the different ways to represent an amount of a component can be interchanged and converted among different representations. For example, a percent weight of one component compared to a percent weight of another component can be converted to a weight ratio of the two components (e.g., as described for a weight ratio of magnesium oxide to phosphate).

Conjunctive language, such as phrases of form “at least one of A, B, and C,” “at least one of A, B and C,” or “any combination thereof,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, ASTM methods, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Furthermore, although subject matter has been described in language specific to compositions and/or methodological acts, it is to be understood that subject matter claimed in appended claims is not necessarily limited to specific features or acts described. Rather, specific features and acts are disclosed as exemplary forms of implementing the claims.

What is claimed is:

1. A solid cementitious material, comprising:
a magnesium oxide;
wollastonite comprising at least 5% weight of a total weight a slurry formed into the solid cementitious material; and
at least one of a phosphate salt, a sulfate salt, and a chloride salt.

2. The solid cementitious material of claim 1, wherein the magnesium oxide comprises crudely-burned magnesium oxide, light-burned magnesium oxide, hard-burned magnesium oxide, dead-burned magnesium oxide, or any combination thereof.

3. The solid cementitious material of claim 1, wherein a ratio of wollastonite:MgO is between 0.6 to 1.2 by weight.

4. The solid cementitious material of claim 1, further comprising a lauric acid, a stearic acid, a metal stearate, or any combination thereof.

5. The solid cementitious material of claim 1, further comprising a filler, a retarder, or any combination thereof.

6. The solid cementitious material of claim 1, wherein the phosphate salt comprises monopotassium phosphate crystals between about 0.05 mm and 0.1 mm.

7. The solid cementitious material of claim 1, wherein the wollastonite comprises between about 5% to 30% weight of the total weight of the slurry formed into the solid cementitious material.

8. The solid cementitious material of claim 1, wherein the sulfate salt comprises magnesium sulfate.

9. The solid cementitious material of claim 1, wherein the sulfate salt comprises magnesium sulfate heptahydrate (MgSO₄·7H₂O) ranging between about 20% to 30% weight of the total weight of the slurry formed into the solid cementitious material.

10. The solid cementitious material of claim 1, wherein the chloride salt comprises magnesium chloride.

11. The solid cementitious material of claim 1, wherein the chloride salt comprises magnesium chloride hexahydrate (MgCl₂·6H₂O) ranging between about 20% to 30% weight of the total weight of the slurry formed into the solid cementitious material.

12. The solid cementitious material of claim 1, wherein the phosphate salt comprises monopotassium phosphate ranging between about 20% to 30% weight of the total weight of the slurry formed into the solid cementitious material.

13. The solid cementitious material of claim 1, wherein a lauric acid and a stearic acid each separately comprises between 0.2-2.0 percent of the total weight of the slurry formed into the solid cementitious material.

14. The solid cementitious material of claim 1, wherein the solid cementitious material comprises a board having a flexural strength greater than about 15 MPa.

15. The solid cementitious material of claim 1, further comprising a lauric acid and a metal stearate, wherein the metal stearate comprises a calcium stearate, a magnesium stearate, a zinc stearate, or any combination thereof.

16. The solid cementitious material of claim 1, further comprising a lauric acid and a metal stearate, wherein the metal stearate comprises a calcium stearate, a magnesium stearate, or a zinc stearate ranging between about 0.2-2.0 percent of the total weight of the slurry formed into the solid cementitious material.

17. The solid cementitious material of claim 1, wherein the solid cementitious material absorbs less than 0.1 mL of water over 24 hours when exposed to a five-inch water column test.

18. The solid cementitious material of claim 1, wherein the solid cementitious material exhibits no deliquescence when exposed to 35° C. and 90% relative humidity for a period of at least 48 hours.

19. The solid cementitious material of claim 1, further comprising water between about 20% to about 40% and ethanol between 0.5% to 3% weight of the total weight of the slurry formed into the solid cementitious material.

20. The solid cementitious material of claim 1, wherein the solid cementitious material comprises a board exhibiting 0 millimeters of warp per foot of a dimension of board.
